(19) United States
(12) Patent Application Publication
(10) Pub. No.: US 2026/0024128 A1
(43) Pub. Date: Jan. 22, 2026

(54) SERVER AND METHOD FOR PROVIDING E-COMMERCE PLATFORM SERVICE PARTICIPATED IN BY MULTIPLE SELLERS IN HIERARCHY

(71) Applicant: CONIALAB CO., LTD., Seoul (KR)

(72) Inventor: HYUN JUNG NA, Gyeonggi-do (KR)

(21) Appl. No.: 18/996,608

(22) PCT Filed: Jul. 13, 2023
(86) PCT No.: PCT/KR2023/010058

§ 371 Date: Jan. 17, 2025

(30) Foreign Application Priority Data
Jul. 18, 2022 (KR) 10-2022-0088557
Oct. 28, 2022 (KR) 10-2022-0141842

(51) Int. Cl. G06Q 30/0601; G06Q 30/0201

(52) U.S. Cl. CPC G06Q 30/06314; G06Q 30/0206; G06Q 30/0641

(57) ABSTRACT

An e-commerce platform server includes a communication device, a memory storing instructions, and a processor executing the instructions stored in the memory, wherein the processor, by executing the one or more instructions, registers supply products of a supplier to be sold in a platform service in a supply product DB, registers sellers in a seller DB in a layer structure including an upper seller and at least one sub-seller subordinate to the upper seller, registers sale products of a top seller of the layer structure in a sales product DB, wherein the sale products are at least one of the supply products registered in the supply product DB, and generates an online shop of a sub-seller including at least one of the registered sale products of the top seller, wherein the sub-seller is subordinate to the top seller, is disclosed.

### BACKGROUND

### 1. Technical Field

The examples disclosed in the present document relate to a platform service technology for providing an e-commerce environment.

### 2. Background Art

With the development of information and communication technology, online commerce, that is, e-commerce, which sells products by building an online market, has been developed. The initial form of online commerce was in the form in which a seller opens an online shopping mall directly, and registers products, and a visitor who accessed the online shopping mall purchases the products, but with the advent of intermediary shopping malls that connect a seller and a purchaser emerged and grew into the form of large shopping malls (e.g.: Auction, 11th Street, G Market, etc.) by providing convenient sales and purchase services, leading to explosive growth in an e-commerce market. Then, the explosive growth trend has continued with the emergence of various forms of e-commerce, in which social commerce using social networks (e.g.: Tmon, Wemakeprice) and off-line innovative distribution logistics services are combined (e.g.: Coupang). These large-scale e-commerce platforms (e.g.: large intermediary platforms, social commerce, etc.) are bringing large profits to a user, especially, a seller.

Recently, a new type of e-commerce market using a channel of a highly influential individual (e.g.: influencer, celeb, etc.) on SNS (Social Network Service) (e.g.: Facebook, Instagram) and personal media (e.g.: Youtube, Tiktok), or using a strong personal network of a community where people with similar personal interests gather is being actively formed.

### SUMMARY

However, even if products are sold using the preceding large-scale e-commerce platform, the seller should bear the initial costs for marketing for product sale (e.g.: creation of product description pages, advertisement, etc.) and product distribution. In addition, the main source of income for this large-scale platform is fees received from users, high fees may be charged to users, especially sellers, depending on the size of the platform. Furthermore, competition for the lowest price with several sellers who have entered stores in the platform may lower a seller's margin rate, which may lead to a decrease in product quality and cause damage to not only purchasers, but also platform services. Even if platform operators and a small number of sellers make a lot of profit in this process, this biased profit structure may stagnate or degrade the development of a platform ecosystem. In addition, the large-scale e-commerce platforms that focus on this intermediary of product sale may have limitations that make it difficult to make key members (e.g.: influencer, community, etc.) of a newly formed e-commerce market through SNS, communities, and the like, as new users.

Furthermore, when many sellers participate in the e-commerce platform, a few managers are difficult to manage the sales status of the many sellers, and when only a few manageable sellers are allowed, it is difficult for the uniform sales method by a few sellers to reflect needs of various purchasers, and the ultimate meaning of a participatory platform where many users participate and create transactions by themselves may fade.

Accordingly, various examples of the present invention are to provide an e-commerce platform service that enables many users to sell products together and share sales profits and at the same time allows many sellers to systemically sell products.

The platform server for providing the e-commerce platform service according to one example disclosed in the present document, may include a communication device: a memory storing one or more instructions: and a processor executing the one or more instructions stored in the memory, wherein the processor, by executing the one or more instructions, may register supply products of a supplier to be sold in a platform service in a supply product DB, register a plurality of sellers in a seller DB in a layer structure consisting of an upper seller and at least one sub-seller subordinate to the upper seller, register sale products of a top seller of the layer structure in a sales product DB, wherein the sale products may be at least one of the supply products registered in the supply product DB, and generate an online shop of a sub-seller including at least one of the registered sale products of the top seller, wherein the sub-seller may be subordinate to the top seller.

In addition, the processor according to one example, by executing the one or more instructions, may determine whether or not to register the top seller based on a response of a manager of the platform service, when the top seller is registered in the seller DB.

Furthermore, the processor according to one example, by executing the one or more instructions, when the sub-seller is registered in the seller DB, may transmit information of the sub-seller to a terminal of the upper seller subordinated by the sub-seller, receive a response that determines whether or not to register from the terminal of the upper seller, and determine whether or not to register from the terminal of the upper seller according to the received response.

Moreover, the processor according to one example, by executing the one or more instructions, when the plurality of sellers are registered in the layer structure, may register the top seller in the seller DB as a master seller, register the sub-seller subordinate to the top seller as a manager seller, and a general seller subordinate to the manager seller in the seller DB, and grant a designated authority to manage the general seller to the manager seller.

In addition, the designated authority according to one example, may include at least one of an authority to determine whether or not to register the general seller, and an authority to check the sales status, delivery status and settlement status of the general seller.

In addition, the processor according to one example, by executing the one or more instructions, may register a plurality of manager sellers subordinate to the master seller, and register a plurality of general sellers subordinate to each of the plurality of manager sellers.

Furthermore, the processor according to one example, by executing the one or more instructions, may receive information for setting the profit rate according to the layer structure from the terminal of the top seller, and set the profit rates of the sellers of the layer structure according to the information for setting the received profit rate.

In addition, the processor according to one example, by executing the one or more instructions, in case of receiving the information for setting the profit rate, may recommend the profit rate of the subordinate sub-seller, when information for setting the profit rate of the top seller is received, and set profits of the sellers of the layer structure according to the recommended profit rate, when an input of the top seller who agrees the recommended profit rate is received.

Moreover, the processor according to one example, by executing the one or more instructions, may provide a UI (User Interface) corresponding to the authority information set for the seller, for each terminal of the plurality of sellers, based on the layer structure.

In addition, the processor according to one example, by executing the one or more instructions, may provide an UI for managing the status of the sub-seller subordinate to the upper seller through the terminal of the upper seller.

In addition, the processor according to one example, by executing the one or more instructions, may provide an UI for managing registration of the subordinate sub-seller and check status information through the terminal of the upper seller.

Furthermore, the processor according to one example, by executing the one or more instructions, may provide an UI for registering sale products through the terminal of the top seller.

The electronic device for providing the e-commerce platform service according to one example disclosed in the present document, may include a communication device: a user interface device: a memory storing one or more instructions; and a processor executing the one or more instructions stored in the memory, wherein the processor, by executing the instructions, may transmit application information for being registered as an upper seller of a layer structure, to which a sub-seller is subordinate, to an e-commerce platform server, thereby registering as an upper seller, register sale products in a sales product DB, through the e-commerce platform server, when registered as a top seller of the layer structure, wherein the sale products may be at least one of supply products registered in a supply product DB by a supplier, and manage the subordinate sub-seller, through the e-commerce platform server.

In addition, the processor according to one example, by executing the one or more instructions, may receive a request for registering the subordinate sub-seller in a seller DB from the e-commerce platform server, and transmit a response that determines whether or not to register the sub-seller based on a user input to the e-commerce platform server.

In addition, the processor according to one example, by executing the one or more instructions, may receive a request for determining whether or not to generate an online shop of the sub-seller from the e-commerce platform server, and transmit a response that determines whether or not to generate the online shop of the sub-seller based on a user input to the e-commerce platform server.

Furthermore, the processor according to one example, by executing the one or more instructions, may transmit a request for checking at least one of the sales status, delivery status, and settlement sate of the subordinate sub-seller based on a user input, and provide the received information to the user, when information corresponding to the request for checking is received from the e-commerce platform server.

The electronic device for providing the e-commerce platform service according to one example disclosed in the present document, may include a communication device: a user interface device: a memory storing one or more instructions; and a processor executing the one or more instructions stored in the memory, wherein the processor, by executing the instructions, may transmit application information for being registered as an sub-seller of a layer structure, to which a sub-seller is subordinated to an upper seller, to an e-commerce platform server, thereby registering as an sub-seller, and generate an online shop including at least one of sale products of a top seller of the layer structure, through the e-commerce platform server.

In addition, the processor according to one example, by executing the instructions, when the online shop is generated, may receive a tool for generating the online shop from the e-commerce platform server, receive a user input for setting the online shop through the received tool, and transmit the received user input to the e-commerce platform server.

The method for providing the e-commerce platform service according to one example disclosed in the present document, may include registering supply products of a supplier to be sold in a platform service in a supply product DB; registering a plurality of sellers in a seller DB in a layer structure consisting of an upper seller and at least one sub-seller subordinate to the upper seller; registering sale products of a top seller of the layer structure in a sales product DB, wherein the sale products may be at least one of the supply products registered in the supply product DB; and generating an online shop of a sub-seller including at least one of the registered sale products of the top seller, wherein the sub-seller may be subordinate to the top seller.

The computer program stored in a computer readable storage medium, and configured to be executed by one or more processors according to one example disclosed in the present document, the computer program for providing an e-commerce platform service, may include an instruction to register supply products of a supplier to be sold in a platform service in a supply product DB: an instruction to register a plurality of sellers in a seller DB in a layer structure consisting of an upper seller and at least one sub-seller subordinate to the upper seller: an instruction to register sales product of a top seller in the layer structure in a sales product DB, wherein the sale products may be at least one of the supply products registered in the supply product DB: and an instruction to generate an online shop of a sub-seller including at least one of the registered sale products of the top seller, wherein the sub-seller may be subordinate to the top seller.

According to the examples disclosed in the present document, the e-commerce platform service provided through a platform server gathers suppliers, sellers and content creators for distributing and selling products in one platform service, thereby easily finding a professional outside his own field and cooperating with each other to sell products. In addition, the e-commerce platform service can reduce risks that users who cooperate in selling products should bear when they sell products on their own, and enable them to focus on their respective professional field and do their best, and further promote product sale by distributing sales profits depending on the ratio of contributing to product sale, thereby making a virtuous cycle structure that increasing each one's profit and develops in each ones' field. Furthermore, this virtuous cycle of the e-commerce platform service can prevent damage to suppliers and sellers due to competition for the lowest price in the conventional open market, and form a sound market that provides high-quality products to purchasers at reasonable prices.

Furthermore, the e-commerce platform service of the platform server can provide various online shops according to the tastes of the plurality of sellers to purchasers and also systemically divide roles to sell products, by registering a plurality of sellers in a layer structure of higher layers and lower layers in the platform service, and at the same time, can bring greater profits to the e-commerce platform users as a greater market is formed, since content creators or purchasers who are participants of the e-commerce platform service, are registered as participants again.

### BRIEF DESCRIPTION OF THE DRAWINGS

FIG. 1 is a diagram that shows the e-commerce environment according to various examples.

FIG. 2 is a diagram that shows the configuration of the e-commerce platform server according to one example.

FIG. 3 is a diagram that shows the configuration of the seller terminal of the e-commerce platform service according to one example.

FIG. 4 is a diagram that shows the flow of the e-commerce platform service according to one example.

FIG. 5 is a diagram that shows the layer structure of the sellers according to one example.

FIG. 6 to FIG. 12 are diagrams that show the GUI (Graphic User Interface) of the master seller according to one example.

FIG. 13 to FIG. 19B are diagrams that show the GUI of the manager seller and general seller according to one example.

FIG. 20 is a diagram that shows the method for providing the e-commerce platform service according to one example.

### DETAILED DESCRIPTION

Provided is an e-commerce platform server, including: a communication device; a memory storing one or more instructions; and a processor executing the one or more instructions stored in the memory, wherein the processor, by executing the one or more instructions, registers supply products of a supplier to be sold in a platform service in a supply product DB, registers a plurality of sellers in a seller DB in a layer structure consisting of an upper seller and at least one sub-seller subordinate to the upper seller, registers sale products of a top seller of the layer structure in a sales product DB, wherein the sale products are at least one of the supply products registered in the supply product DB, and generates an online shop of a sub-seller including at least one of the registered sale products of the top seller, wherein the sub-seller is subordinate to the top seller.

Hereinafter, various examples of the present invention will be described with reference to the attached drawings. However, this is not intended to limit the present invention to specific embodiments, but should be interpreted to include various modifications equivalents, and/or alternatives of the examples of the present invention.

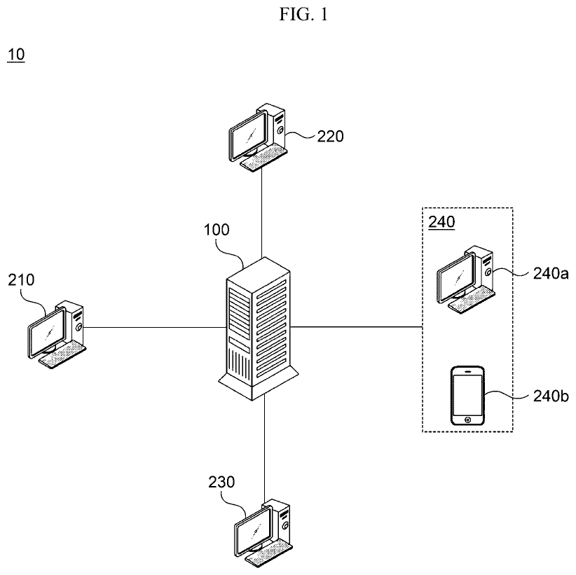

FIG. 1 is a diagram that shows the e-commerce environment according to various examples.

Referring to FIG. 1, the e-commerce environment (10) may include a platform server (100), a supplier terminal (210), a seller terminal (220), a content creator terminal (230) and a purchaser terminal (240). The platform server (100) may be connected with the supplier terminal (210), seller terminal (220), content creator terminal (230) and purchaser terminal (240) through a communication network.

The platform server (100) may provide an e-commerce platform service through a user terminal (210, 220, 230, 240). The e-commerce platform service may include an overall necessary service for selling products online such as product supply, sales, promotion and purchase.

According to one example, the platform server (100) may provide a service needed for supplying platform products to the supplier.

According to one example, the platform server (100) may register the supplier of the products to be sold in the platform service. The supplier may be, for example, a person who supplies products to be sold in the platform service and delivers the products sold by the seller. Accordingly, the supplier may be a person who is charge of product distribution and delivery, and leaves the rest to other users. According to one example, registering in the platform service may be understood as registering in the platform service as a participant performing a designated role. According to one example, the supplier may be approved for registration based on designated criteria. The designated criteria may include criteria that can determine the reliability of the supplier, such as the business period, capital size, sales scale, brand value, and the like. According to one example, the supplier may be approved according to stringent criteria (or high criteria). Accordingly, products may be stably supplied on the platform by the highly reliable supplier.

According to one example, the platform server (100) may register supply products of suppliers in the platform service through the supplier terminal (210). According to one example, the products may be approved for registration according to the designated criteria. The designated criteria may include criteria that can predict the sales volume of the products, such as the product quality, consumer preference, brand involvement, market share, distribution margin structure, and availability of exclusive distribution, and the like. According to one example, the products may be approved according to stringent criteria. Accordingly, users (e.g.: seller, content creator) who can contribute to promotion of product sale as products with high sales are registered can participate more in the platform service, thereby making high synergy.

According to one example, the platform server (100) may provide a total solution needed for supplying products through the supplier terminal (210). For example, the platform server (100) may provide a solution through a GUI (Graphic User Interface).

According to one example, the platform server (100) may provide a service for managing registration of supply products through the supplier terminal (210). According to one example, the platform server (100) may provide the list of supply products registered in the platform service. According to one example, the platform server (100) may renew the list of supply products registered in the platform service. For example, the platform server (100) may receive application information for registering a new supply product in the platform service from the suppliers, and when registration is approved, a new supply product may be added in the list. According to one example, the platform server (100) may receive request information for deleting the registered supply products from the suppliers, and delete the requested supply products in the list.

According to one example, the platform server (100) may provide a service for managing product sale through the supplier terminal (210). According to one example, the platform server (100) may provide sale information of the supply products registered in the platform service. The sale information may include information such as sales volume, order amount, deposit amount, and the like. According to one example, the platform server (100) may provide a service for managing the stock of supply products. According to one example, the platform server (100) may provide a service for managing order, delivery and refund. According to one example, the platform server (100) may provide settlement information of sold products. The settlement information may include information such as sales, adjusted amount and deposit amount. According to one example, the platform server (100) may process the processor for paying the adjusted amount, when a settlement request is received from the suppliers.

According to one example, the platform server (100) may provide a service for managing a community for the products registered in the platform service through the supplier terminal (210). For example, the platform server (100) may provide community information such as notices, product FAQ (Frequently Asked Question), product Q&A (Question and Answer), product review, and the like, focusing on products to be supplied. According to one example, the suppliers can register information related to the products themselves in the community. The information that can be registered, may include, for example, information on inquiries (or, product Q&A) about products of the sellers and purchasers.

According to one example, the platform server (100) may provide a service needed for product sale to the sellers through the seller terminal (220).

According to one example, the platform server (100) may register the sellers in the platform service through the seller terminal (220). The seller, may be, for example, a person who sells the supply products registered in the platform service by the suppliers. According to one example, the sellers may consist of a layer structure. The layer structure may consist of, for example, upper sellers, and sub-sellers subordinate to the upper sellers. According to one example, the sub-sellers subordinate to the upper sellers may be subordinate to the upper sellers in terms of products that can be sold and sales conditions, and should pay a part of the sales amount to the upper sellers as a commission. According to one example, the sellers may be approved for registration according to the designated criteria. The designated criteria may be applied differently, for example, depending on the layer of the sellers. The top seller may be approved for registration with stringent criteria based on reliability similar to the suppliers, such as sales volume, capital size, personal network size, and the like. The sub-sellers (e.g.: secondary seller, tertiary seller) may be registered in the platform service by approval of the upper sellers. Accordingly, under the direction of the reliable top seller, the supply products registered in the platform service may be sold by various methods in professional and several online shops (or, online shopping malls).

According to one example, the platform server (100) may register sale products of sellers in the platform service through the seller terminal (220). For example, the platform server (100) may register sale products of the top seller. In other words, the platform server (100) may allow only the top seller to apply sale approval of a new product. The sub-sellers of the top seller may not directly apply sale approval of a new product, and may select products of the products approved for sale of the top seller and sell them. According to one example, the sale products may be approved according to the designated criteria. The designated criteria may include criteria that can determine whether or not to sell products professionally, such as, the seller's area of activity, capital size, conventional sale products, sales volume, and the like. According to one example, the approval criteria of the sale products may be high. Accordingly, the supply products registered in the platform service may bring high profits to not only the suppliers but also users contributing to product sale (e.g.: sellers, content creators), as product information is delivered to purchasers with high interest by an appropriate marketing method by professional sellers.

According to one example, the platform server (100) may provide a solution for generating an online shop in the platform. For example, the platform server (100) may provide a function that can set the online shop by the drag and drop method through an GUI without hard coding. In addition, the platform server (100) may provide a design template produced in advance. According to one example, the platform server (100) may register sale products of sellers in the online shop. The sale products, may be, for example, products approved for sales to the sellers. According to one example, the platform server (100) may generate an online shop requested by the sellers. For example, the platform server (100) may generate online shops generated by each of the sellers. Each of the sellers may generate a separate online shop according to his own taste. Accordingly, the purchasers may purchase products registered in the online shop as a member by selectively joining an online shop that suits their own tastes in the platform service.

According to one example, the platform server (100) may provide a sales service of products registered in the generated online shop to users who visit the platform. For example, the platform server (100) may allow the users who directly visit the platform to search products through a route (e.g.: search, online shop visit) in the platform, and purchase the searched products. The information of the products registered in the online shop may be made unsearchable through, for example, portal services (e.g.: NAVER, Yahoo). Accordingly, user loyalty to the platform service may be increased, and bleeding of the suppliers and sellers due to excessive competition for the lowest price may be prevented.

According to one example, the platform server (100) may provide a total solution required for selling products. For example, the platform server (100) may provide a solution through an GUI.

According to one example, the platform server (100) may provide a service for management of the online shop through the seller terminal (220). For example, the platform server (100) may provide a solution for setting the name, URL, logo, banner and the like of the online shop.

According to one example, the platform server (100) may provide a service for managing human resources through the seller terminal (220). According to one example, the platform service may provide a service that can manage sub-sellers. The upper sellers may approve registration of the sub-sellers through the service for managing. According to one example, the platform server (100) may provide member information of the online shop. The member information may include, for example, not only member information of his own online shop, but also member information of the online shop of the sub-sellers.

According to one example, the platform server (100) may provide a service for managing registration of sale products through the seller terminal (220). According to one example, the platform server (100) may provide the list of the sale products registered in the platform service. According to one example, the platform server (100) may renew the list of the sale products registered in the platform service. For example, the platform server (100) may receive a request of approval for selling a new product from the seller, and when the selling is approved, the new product may be added to the list. The seller may be, for example, the top seller in the layer structure. According to one example, the platform server (100) may set the profit rate for distributing profits of the products sold from the sellers. For example, the platform server (100) may set the profit rate according to the determination of the upper sellers in the layer structure. The upper sellers may be, for example, the top seller. According to one example, the profit rate may be a profit rate of each of the upper sellers subordinated by the sub-sellers and the sub-sellers, for product sale of the sub-sellers in the layer structure.

According to one example, the platform server (100) may provide a service for managing product sale through the seller terminal (220). According to one example, the platform server (100) may provide sale information of the products sold in the online shop. The sale information may include not only information similar to information provided into the suppliers, such as sales volume, order amount, deposit amount, and the like, but also purchaser information. The purchaser information may be, for example, member information of the online shop. According to one example, the platform server (100) may provide a service for managing order, delivery and refund. According to one example, the platform server (100) may provide settlement information of the products sold. The settlement information may include information on the sales volume, adjusted amount and deposit amount, similar to the information provided to the suppliers. According to one example, the adjusted amount may be determined according to the profit rate settings of the upper sellers. According to one example, the platform server (100) may process a process for paying the adjusted amount, when a settlement request is received from the sellers. According to one example, the platform server (100) may provide the sale information of the sub-sellers to the upper sellers. The sale information may include, for example, information on sales, order, delivery and refund, provided in the service for managing product sale.

According to one example, the platform server (100) may provide a service for managing a community for sales products registered in the platform service through the seller terminal (220). For example, the platform server (100) may provide a solution that can manage notices, product FAQ, product Q&A, product reviews, and the like, centered around the online shop. The sellers may upload information to the notices and product FAQ, and answer to the product Q&A and reviews. According to one example, the platform server (100) may provide the community information of the sub-sellers to the upper sellers. The upper sellers may check the community information of the sub-sellers and manage it.

According to one example, the platform server (100) may provide a service needed for contents supply through the content creator terminal (230).

According to one example, the platform server (100) may register the content creator in the platform service. The content creator may, for example, create contents helpful for sales of products, and provide the created contents to the suppliers and sellers. According to one example, the content creator may be a professional directly and indirectly needed for creating contents. The professional manpower may include, for example, models, hair and makeup professionals, stylists, photographers, and the like. In addition, the models may be influencers, celebs, and the like, on the online social media.

According to one example, the platform server (100) may provide a service that can share the contents created by the content creator with platform users. For example, the platform server (100) may provide a content share service that uses platform users as a social network, in other words, a social network service (SNS). According to one example, the platform server (100) may register contents of the content creator in the platform service. According to one example, the platform server (100) may provide the registered contents to the platform users through the content share service. The contents shared through the content share service may be contents for promotion of products sold in the platform service. According to one example, the contents may include information (e.g.: URL) on the online shop in the platform where the products being promoted are being sold. Accordingly, the purchasers may move to the designated shopping mall through the information and purchase products. According to one example, the platform server (100) may provide information on participants (e.g.: models, hair and makeup professionals, stylists, photographers, etc.) who participate creating contents together with the contents. Accordingly, the suppliers and purchasers may easily check all the interested parties required for creating contents as well as the models.

According to one example, the platform server (100) may provide a service to connect the suppliers and sellers to the content creator. According to one example, the platform server (100) may connect the suppliers and sellers who would like to request creating contents for promotion of products to the content creator. For example, the platform server (100) may connect participants required for creating contents, such as not only models matched to the image of product, but also hair and makeup professionals, stylists, and the like, at a time. According to one example, the platform server (100) may connect the suppliers and sellers who would like to sponsor products to the content creator. According to one example, the platform server (100) may connect the content creator predicted to have high promotion effects to the suppliers and sellers. For example, the platform server (100) may connect the content creator predicted to have high promotion effects, based on conventionally created contents, sales of products of the created contents, and the like.

According to one example, the platform server (100) may provide a total solution needed to supply contents through the content creator terminal (230) to the content creator. For example, the platform server (100) may provide a solution through a GUI.

According to one example, the platform server (100) may provide a service for managing content creation through the content creator terminal (230). According to one example, the platform server (100) may provide contract information related to content creation and product sponsorship. The contract information may include, for example, not only contract information accepted and progressed and completed, but also information about requests for creation of contents and proposals of sponsorship of products. According to one example, the platform server (100) may progress a process for contract when the content creator accepts the requests for creation and proposals of sponsorship. According to one example, the platform server (100) may provide profit information. The profit information may include, for example, profit information according to content creation. According to one example, the platform server (100) may provide settlement information according to the profits. According to one example, the platform server (100) may handle a process for paying the adjusted amount, when a settlement request is received from the content creator.

According to one example, the platform server (100) may provide a service needed for purchasing products to the purchasers through the purchaser terminal (240).

According to one example, the platform server (100) may register the purchasers on the online shops of the sellers as a member. For example, the platform server (100) may register the purchasers on the online shop of each seller as a member.

According to one example, the platform server (100) may receive order and delivery information of the purchasers who purchased products through the online shop. According to one example, the platform server (100) may provide a payment service to the purchasers who purchased products. According to one example, the platform server (100) may transmit the order information to the suppliers and sellers, when the payment is completed. Accordingly, the suppliers can deliver the ordered products to the purchasers.

According to one example, the platform server (100) may provide a service for managing the order status through the purchaser terminal (240). According to one example, the platform server (100) may provide order and delivery information of products purchased in the online shop. According to one example, the platform server (100) may correct the order information based on the received correction information, when correction information of the order is received.

According to one example, the manager of the platform server (100) may approve registration of the platform service. According to one example, the manager of the platform server (100) may approve registration of the platform user. For example, the manager may approve registration of the suppliers and sellers. The seller for approval of registration may be, for example, the top seller. According to one example, the manager of the platform server (100) may approve registration of products. For example, the manager may approve the supply products of the suppliers, and the sales products of the sellers. The sales products may be, for example, sales products of the top seller. According to one example, the manager of the platform server (100) may access the platform server (100) through a separate terminal to approve registration of the service.

According to one example, the manager of the platform server (100) may check the status information for managing the overall status of the suppliers and sellers. The status information may include, for example, sales information (e.g.: sales amount information, settlement information, delivery information, etc.), settlement information, and order and delivery information. According to one example, the manager of the platform server (100) may check community information. The community information may include, for example, online shops, and notices, FAQ, Q&A, reviews, and the like about products sold in the online shops.

According to one example, the manager of the platform server (100) may register suppliers, sellers, and content creators introduced from a collector according to the aforementioned procedure. According to one example, the collector may perform a role to make more users participate in the platform service as a separate entity from the manager.

According to one example, the platform server (100) may include not only a computing module required for providing an e-commerce platform service, but also a database (DB) for data storage. In other words, the platform server (100) may include a server configuration generally required for providing the e-commerce service. According to one example, the platform server (100) may provide useful information to service users by analyzing information stored in the database. The useful information may include, for example, basic data useful for product supply, product sale, content creation and product purchase, and processed data.

The supplier terminal (210) may be a terminal of the supplier for using the e-commerce platform service provided from the platform server (100) to the supplier.

According to one example, the supplier terminal (210) may receive information for managing product supply from the platform server (100). For example, the supplier terminal (210) may receive information for registration of supply products, sales of supply products, and managing communities of supply products. According to one example, the supplier terminal (210) may transmit information input from the supplier to manage product supply to the platform server (100). For example, the supplier terminal (210) may transmit application information for registering a new supply product. In addition, the supplier terminal (210) may transmit information input from the supplier to manage order, delivery and community of supply products. According to one example, the supplier terminal (210) may provide information for managing product supply through the GUI, and receive information required for managing product supply form the supplier.

The seller terminal (220) may be a terminal of a seller to use the e-commerce platform service provided from the platform server (100) to the sellers.

According to one example, the seller terminal (220) may be provided with a service for generating a shopping mall provided from the platform server (100). The service for generating the online shop may include information required for generating a shopping mall by drag and drop through a GUI, and a method for providing a template. According to one example, the seller terminal (220) may transmit information input from the seller to generate an online shop from the platform server (100). Accordingly, the online shop of the seller may be generated on the platform.

According to one example, the seller terminal (220) may transmit information for managing product sale from the platform server (100). For example, the seller terminal (220) may transmit information for registration of sales products, selling sales products, management of human resources, and managing communities of the online shop. The human resource management may include, for example, managing sub-sellers and members. According to one example, the seller terminal (220) may transmit information input from the sellers to manage product sale from the platform server (100). For example, the seller terminal (220) may transmit application for registering a new sales product. The application for the new sales product may be for example, by the top seller. In addition, the seller terminal (220) may transmit information input from the seller to manage the order, delivery and community of the supply products. According to one example, the seller terminal (220) may provide information for managing product supply through the GUI to the sellers, and receive information required for managing product sale from the sellers.

The content creator terminal (230) may be a seller terminal for using the e-commerce platform service provided by the content creator from the platform server (100).

According to one example, the content creator terminal (230) may be provided with a service that can share contents with platform users. The service that can share contents may be SNS that uses the platform users as a social network. According to one example, the content creator terminal (230) may transmit the created contents to the platform server (100). Accordingly, the contents of the content creator may be shared on the platform.

According to one example, the content creator terminal (230) may transmit information of content creation request and sponsorship provision from the platform server (100). According to one example, the content creator terminal (230) may transmit a response that accepts creation request and sponsorship provision to the platform server (100). Accordingly, content creation or sponsorship contract with the supplier or seller may be concluded.

According to one example, the content creator terminal (230) may transmit information for managing content creation from the platform server (100). For example, the content creator terminal (230) may transmit contract information, profit information and settlement information from the platform server (100). According to one example, the creator terminal (220) may provide the received information through a GUI to the seller, and receive information required for managing content creation and sponsorship contract from the content creator.

The purchaser terminal (240) may be a purchaser terminal for using the e-commerce platform service provided to the purchaser from the platform server (100).

According to one example, the purchaser terminal (240) may receive online shop information. According to one example, the purchaser terminal (240) may transmit order information of a consumer. Accordingly, product purchase may be made.

According to one example, the user terminals (210, 220, 230, 240) may be general-purpose devices such as desktop PCs (desktop personal computer), laptop PCs (notebook PCs), smartphones, tablet PCs, PDAs (personal digital assistants) and the like. For example, the supplier terminal (210), seller terminal (220) and user terminal (230) may be an electronic device with relatively low portability, such as a desktop PC, a laptop PC, and the like, and the purchaser terminal (240) may be a smartphone (240b) as well as a desktop PC (240a) with low portability.

The afore-mentioned e-commerce environment (10) may provide an e-commerce platform service in which a supplier who supplies products, a seller who sells products by generating an online shop, and a creator who creates contents for promotion of products coexist on one platform, and they sell products to purchasers and share profits for product sale.

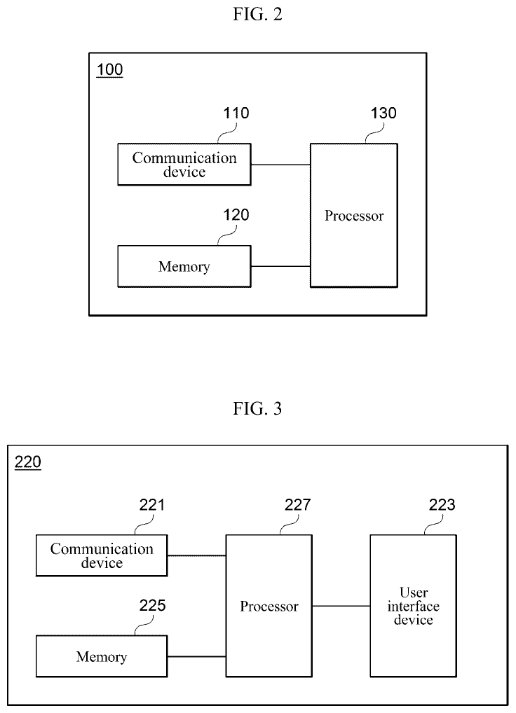

FIG. 2 is a diagram that shows the configuration of the e-commerce platform server according to one example.

Referring to FIG. 2, the platform server (100) may include a communication device (100), a memory (120) and a processor (130). However, all the components illustrated are not essential components. The platform server (100) may be implemented by more components than the illustrated components, and the platform server (100) may be implemented even by fewer components than them.

The communication device (110) may perform communication with an external device. For example, the communication device (110) may be connected with a network in a wired or wireless manner and perform communication with an external device. Herein, the external device may be a user terminal (e.g.: user terminals of FIG. 1 (210, 220, 230, 240)).

The communication device (110) may include a communication module that supports one of various wired and wireless communication methods. The communication module may be a short-distance communication module, or a wired communication module.

The memory (120) may include at least one type of storage medium among flash memory type, hard disk type, multimedia card micro type, card-type memory (SD, XD memory, etc.), RAM (Random Access Memory), SRAM (Static Random Access Memory), ROM (Read-Only Memory), EEPROM (Electrically Erasable Programmable Read-Only Memory), PROM (Programmable Read-Only Memory), a magnetic memory, a magnetic disk, and an optical disk.

The memory (120) may store at least one program for providing the e-commerce platform service in which users for product supply, product sale, content provision, and purchase participate in the platform server (100). The at least one program stored in the memory (1020) may be classified into a plurality of modules according to functions.

The memory (120) may include a DB for registering information of the products, suppliers, sellers, content creators, and purchasers. However, the DB is a separate storage device, and may be implemented outside the platform server (100) and be connected directly or through a communication network.

The processor (130) controls overall operations of the platform server (100), and may include at least one processor such as CPU and the like. The processor (130) may include at least one specialized processor corresponding to each function, or be a processor in the form integrated into one.

The processor (130) may execute a program stored in the memory (120), read data or files stored in the memory (120), or store a new file in the memory (120). In addition, the processor (130) may execute instructions stored in the memory (120). Accordingly, the processor (130) may perform the following operations.

The operation performed by executing the instructions of the processor (130) may be understood as an operation of the platform server (e.g.: platform server (100) of FIG. 1).

According to one example, the processor (130) may register suppliers of products to be sold in the platform service in a supplier DB through the supplier terminal (e.g.: supplier terminal (210) of FIG. 1). According to one example, being registered in the DB may be understood as storing information on a target to be registered. According to one example, the processor (130) may receive application information for registering as the supplier from the supplier terminal. The application information may include, for example, supplier information that can identify the supplier and determine whether or not to register the supplier. According to one example, the processor (130) may determine whether or not to register the supplier based on the response of the manager of the platform service. Whether or not to register the supplier, may be determined for example, based on the designated criteria that can determine the reliability of the supplier. According to another example, the processor (130) may determine whether or not to register the supplier based on the designated criteria. For example, the processor (130) may automatically determine whether or not to register the supplier based on the criteria stored in the memory (120). According to one example, the processor (130) may register the supplier in the supplier DB according to the determination of whether or not to register.

According to one example, the processor (130) may register supply products in the supply product DB through the supplier terminal. The supply products may be, for example, products of suppliers to be sold in the platform service. According to one example, the processor (130) may receive application information for registering supply products from the supplier terminal. The application information may include, for example, supply product information that can identify supply products and determine whether or not to register supply products. According to one example, the processor (130) may determine whether or not to register supply products based on the response of the manager of the platform service. Whether or not to register supply products may be determined based on the designated criteria that can predict the sales volume of products. According to another example, the processor (130) may determine whether or not to register supply products based on the designated criteria. For example, the processor (130) may automatically determine whether or not to register supply products based on the criteria stored in the memory (120). According to one example, the processor (130) may register supply products in the supply product DB according to the determination of whether or not to register.

According to one example, the processor (130) may provide a total solution required for supplying products through the supplier terminal. The solution may include, for example, services for managing registration of sales products, selling of supply products, and communities of supply products. The service for managing product sale may include services for providing sales information of the registered supply products, managing stock of supply products, and managing order, delivery and refund. According to one example, the processor (130) may provide a solution needed for supplying products through a GUI.

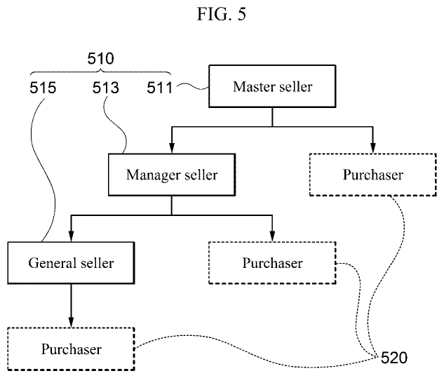

According to one example, the processor (130) may register the sellers in the seller DB through the seller terminal (e.g.: seller terminal (220)). For example, when a plurality of sellers are registered in the seller FB, the processor (130) may register them in the seller DB in the layer structure consisting of upper sellers and at least one sub-seller subordinate to the upper sellers. According to one example, the processor (130) may register the top seller in the layer structure as a master seller, and register sub-sellers subordinate to the top seller as manager sellers and general sellers subordinate to the manager seller. According to one example, the processor (130) may grant the designated authority to the manager seller so as to manage he general sellers. The layer structure will be described in more detail in FIG. 5.

According to one example, the processor (130) may receive application information for registering as the seller from the seller terminal. The application information may include, for example, seller information that can identify the sellers and determine whether or not to register the sellers. According to one example, the processor (130) may determine whether or not to register the top seller based on the response of the manager of the platform service. For example, the processor (130) may provide the received product information, and determine whether or not to register the top seller according to whether or not to approve the manager. Whether or not to register the top seller may be determined, for example, based on the designated criteria that can determine the reliability of the seller. The designated criteria may be criteria determined in advance to objectively determine the reliability of the seller. According to one example, the processor (130) may determine whether or not to register subordinate sub-sellers based on the response of the upper sellers. For example, the processor (130) may transmit information of the sub-sellers to the terminal of the upper sellers subordinated by the sub-sellers, receive a response that determines whether or not to register from the terminal of the upper sellers, and determine whether or not to register the sub-sellers according to the received response. Whether or not to register the sub-sellers may be determined, for example, according to the subjective criteria of the top seller differently from the top seller. According to another example, the processor (130) may determine whether or not to register the sellers based on the designated criteria. For example, the processor (130) may automatically determine whether or not to register the sellers according to the criteria stored in the memory (120). According to one example, the processor (130) may register the sellers in the seller DB according to the determination of whether or not to register.

According to one example, the processor (130) may register the sales products in the sales product DB through the seller terminal. According to one example, the processor (130) may register the sales products of the top seller in the sales product DB. The sales products may be for example, at least one of the supply products registered in the supply product DB. In other words, it may select at least one of the supply products registered by the supplier and register it as a sales product. According to one example, the processor (130) may receive application information for registering sales products from the top seller terminal. The application information may include, for example, sales product information that can identify products, and seller information needed for determining whether or not to register sales products. According to one example, the processor (130) may determine whether or not to register the sales products based on the response of the manager of the platform service. Whether or not to register the sales products may be determined for example, according to the criteria that can determine whether or not to sell products professionally. According to one example, the processor (130) may allow the sub-sellers subordinate to the top seller to sell products in the registered sales products of the top seller. In other words, the sales products of the sub-sellers are subordinate to the registered sales products of the top seller to whom they are subordinate. In addition, the sub-sellers cannot request separate registration of sales products. According to another example, the processor (130) may determine whether or not to register the sales products according to the designated criteria. For example, the processor (130) may automatically determine whether or not to register according to the criteria stored in the memory (120). According to one example, the processor (130) may register the sales products in the sales product DB according to whether or not to register.

According to one example, the processor (130) may provide a solution for generating an online shop in the platform through the seller terminal. According to one example, the processor (130) may receive user input for setting the online shop from the seller terminal. The user input may be, for example, dragging and dropping the configuration of the online shop at the designated position through a GUI. In addition, the user input may be inputted based on the design template produced in advance. According to one example, the processor (130) may generate an online shop in which at least one of the products registered in the sales product DB based on the received user input is registered. According to one example, the processor (130) may generate each online shop of the plurality of sellers. For example, the processor (130) may generate online shops of the sub-sellers subordinate to the top seller. The generated online shop may include, for example, at least one of the registered sales products of the top seller registered in the sales product DB. In addition, it may generate online shops of not only the sub-sellers, but also the top seller.

According to one example, the processor (130) may provide a total solution required for selling products through the seller terminal. The solution may include, for example, services for managing online shops, human resources, registration of sales products, selling sales products, and managing communities of the online shops. The service for managing human resources may include a service for managing sub-sellers and members. The service for managing product sale may include services for providing sales information of products to be sold, and managing order, delivery and refund. According to one example, the processor (130) may provide status information of the sub-sellers subordinate to the upper sellers in the layer structure. The status information may include information about for example, human resources, product sale and community. According to one example, the processor (130) may provide a solution required for supplying products through a GUI.

According to one example, the processor (130) may provide a GUI corresponding to the set authority information to the sellers, by each terminal of the plurality of sellers, based on the layer structure. According to one example, the processor (130) may provide a GUI managing the status of the sub-sellers subordinate to the upper seller to the terminal of the upper seller. For example, the processor (130) may provide a GUI for managing registration of the subordinate sub-sellers to the terminal of the upper sellers in the status layer structure, and checking the status information. According to one example, the processor (130) may provide an GUI for managing registration of sales products to the terminal of the top seller.

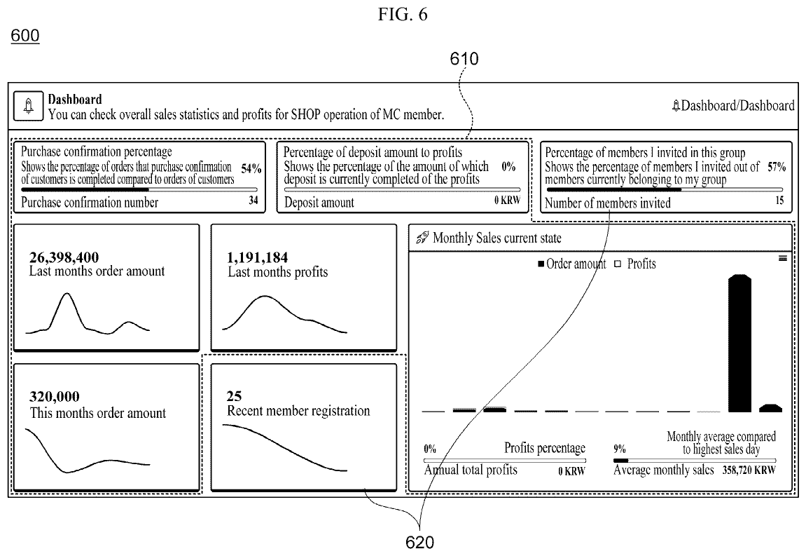

The GUI provided to the seller will be described in more detail in FIG. 6 to FIG. 19B.

According to one example, the processor (130) may set the profit rate for distributing profits of products sold through the seller terminal. According to one example, the processor (130) may receive information for setting the profit rate according to the layer structure of the sellers from the terminal of the top seller. For example, the processor (130) may recommend the profit rate of the subordinate sub-sellers, when the information for setting the profit rate of the top seller is received. According to one example, the processor (130) may set the profit rate of the sellers of the layer structure according to the information for setting the received profit rate. For example, the processor (130) may set the profits of the sellers of the layer structure according to the recommended profit rate, when the input of the top seller that agrees the recommended profit rate is received.

According to one example, the processor (130) may register the content creator in the content creator DB through the content creator terminal (e.g.: content creator terminal (230) of FIG. 1). According to one example, the processor (130) may receive application information for registering as a content creator from the content creator terminal. The application information may include, for example, information that can identify the content creator. According to one example, the processor (130) may register the content supplier based on the received application information. The content creator may be, for example, a professional directly or indirectly needed for creating contents.

According to one example, the processor (130) may provide a service that can share contents with the platform users through the content creator terminal. According to one example, the processor (130) may receive contents for promoting products registered in at least one of the supply product DB and sales product DB from the content creator terminal. According to one example, the processor (130) may register the received contents in the content DB. According to one example, the processor (130) may provide the contents registered in the content DB to the platform users. For example, the processor (130) may provide contents uploaded in the space that can identify the content creator to purchasers through the purchaser terminal. The contents may be, for example, requested by the supplier or seller through the platform service.

According to one example, the processor (130) may provide a service to connect the supplier and seller to the content creator through the content creator terminal. For example, the processor (130) may connect the content creator for requesting content creation for promotion of products, or sponsoring products. According to one example, the processor (130) may upload the connected contents on the online shop of the seller and provide them to the users of the platform service. For example, the processor (130) may provide product purchase pages where contents are uploaded through the purchaser terminal.

According to one example, the processor (130) may provide recommended information for the content creator expected to have a high promotional effect through the supplier terminal and seller terminal. The recommended information may be provided, for example, based on the information of the created contents.

According to one example, the processor (130) may provide a total solution required for supplying contents through the content creator terminal. The solution may include, for example, a service for managing contract, profits, and settlement with the supplier and seller. According to one example, the processor (130) may provide a solution needed for supplying products through a GUI.

According to one example, the processor (130) may provide a service required for product purchase to purchasers through the purchase terminal (e.g.: purchaser terminal (240) of FIG. 1). According to one example, the processor (130) may receive purchase information of the purchaser who purchased products from the purchaser terminal. According to one example, the processor (130) may transmit the received order information to the supplier terminal and seller terminal, when payment is completed. For example, the processor (130) may transmit the received order information to the supplier terminal to make the supplier deliver products to the purchaser.

Accordingly, the e-commerce platform server (100) may provide a platform service for product sale online.

FIG. 3 is a diagram that shows the configuration of the seller terminal of the e-commerce platform service according to one example.

Referring to FIG. 3, the seller terminal (220) may include a communication device (221), a user interface device (223), a memory (225) and a processor (227). However, all the components illustrated are not essential components. The seller terminal (220) may be implemented by more components than the illustrated components, and the seller terminal (220) may be implemented even by fewer components than them.

The communication device (221) may be connected to a network in a wired or wireless manner to perform communication with the platform server (100) and an external device of other user terminals (210, 230, 240). Herein,

the memory (223) may store at least one program for providing functions required for selling products in the e-commerce platform service of the platform server (e.g.: platform server (100)) through the seller terminal (220).

The user interface device (225) may include an output device that can output information generated or handled in the platform server, and an input device that can receive user input transmitted to the platform server. The output device may include various kinds of output interfaces such as a display, a speaker, a touchscreen, and the like. The input device may include input interfaces such as a touchscreen, a keyboard, a mouse, and a touch pad.

The processor (227) may execute programs stored in the memory (223), or read data or files stored in the memory (223), or store a new file in the memory (223). In addition, the processor (227) may execute instructions stored in the memory (223). Accordingly, the processor (227) may perform the following operations.

According to one example, the processor (227) may register sellers in the platform server through the platform server. The sellers may include, for example, upper sellers in the layer structure, and sub-sellers subordinate to the upper sellers. According to one example, the processor (227) may transmit application information for being registered as the upper sellers in the layer structure, in which the sub-sellers are subordinate, and register them as the upper sellers. According to one example, the processor (227) may transmit application information for being registered as the sub-sellers in the layer structure, who are subordinate to the upper sellers, and register them as the sub-sellers. The application information may include, for example, seller information required to be registered as a seller.

According to one example, the processor (227) may register sales products in the platform service through the platform server. For example, the processor (227) may register sales products in the platform service, when the seller is registered as the top seller in the layer structure. The sales products may be, for example, at least one of the supply products registered by the suppliers. According to one example, the processor (227) may transmit application information for registering sales products to the platform server. The application information may include, for example, sales product information and seller information required for registering sales products.

According to one example, the processor (227) may generate an online shop of the seller through the platform server. For example, the processor (227) may generate an online shop including at least one of sales products of the top seller in the layer structure. According to one example, the processor (227) may receive a tool for generating an online shop from the platform server. The received tool may provide a function that can set an online shop by a drag and drop method through a GUI, and also provide a template produced in advance. According to one example, the processor (227) may receive user input that sets an online shop through the tool received to the platform server. According to one example, the processor (227) may transmit the received user input to the platform server and generate an online shop of the seller.

According to one example, the processor (227) may provide a total solution for selling products through the platform server. For example, the processor (227) may receive information for managing registration of sales products, selling of sales products, managing human resources, and managing communities of the online shop. According to one example, the processor (227) may manage the subordinate sub-sellers. According to one example, the processor (227) may receive a request for registering the subordinate sub-sellers from the platform server, and transmit the response that determines whether or not to register the sub-seller based on the user input, thereby managing registration of the sub-sellers. According to one example, the processor (227) may receive a request for determining whether or not to generate online shops of the sub-sellers from the platform server, and transmit a response that determines whether or not to generate the online shop based on the user input. According to one example, the processor (227) may transmit a request for checking at least one of the sales status, delivery status, and settlement status of the subordinate sub-sellers to the platform server based on the user input, and provide the received information to users, when information corresponding to the request for checking is received from the platform server.

Accordingly, the seller terminal (220) makes a plurality of sellers can sell products in the e-commerce platform service.

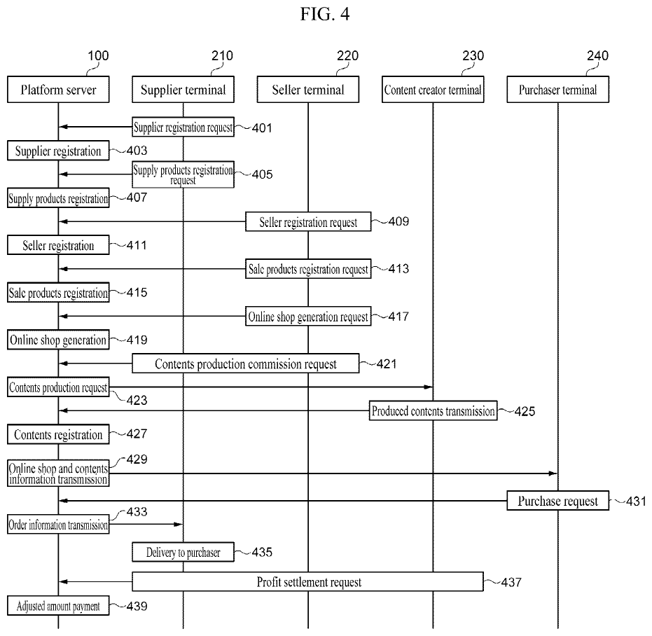

FIG. 4 is a diagram that shows the flow of the e-commerce platform service according to one example.

Referring to FIG. 4, the platform server (100) may provide a platform service in which the supplier, seller and content creator participate and sell products to the purchaser.

According to one example, the supplier terminal (210) may transmit (401) a request to be registered as a supplier in the platform service to the platform server (100) according to the user input of the supplier. The request to be registered as the supplier may include, for example, supplier information required for application for registration. According to one example, the supplier terminal (210) may register (403) the supplier in the platform service according to the request for registration of the supplier. The registration of the supplier may be determined, for example, by the manager of the platform server (100).

According to one example, the supplier terminal (210) may transmit (405) a request for registering supply products in the platform service according to the user input of the supplier to the platform server (100). The request for registering supply products may include, for example, supply product information required for application of registration. According to one example, the platform server (100) may register (407) the supply products in the platform service according to the received request for registration of the supply products. The registration of the supply products may be determined, for example, by the manager of the platform server (100).

According to one example, the seller terminal (220) may transmit (409) a request to be registered as a seller in the platform service according to the user input of the seller to the platform server (100). The request to be registered as a seller may include, for example, seller information required for application of registration. According to one example, the platform server (100) may register (4011) the seller in the platform service according to the request for registration of the received seller. The registration of the seller may be, for example, determined by the manager of the platform server (100) in case of the top seller in the layer structure of the seller, and determined by the upper seller subordinated by the sub-seller, in case of the sub-seller.

According to one example, the seller terminal (220) may transmit (413) a request for registering sales products in the platform service according to the user input of the seller. For example, it may transmit a request for registering sales products of the top seller of the seller terminal (200). The sales products may be at least one of the sales products registered in the platform service. According to one example, the platform server (100) may register (415) the sales products in the platform service according to the received request for register the sales products. The registration of the sales products may be determined, for example, by the manager of the platform server (100).

According to one example, the seller terminal (220) may transmit (417) a request for generating an online shop to the platform server (100) according to the user input of the seller. The user input for generating the online shop may be, for example, the user input for setting the online shop. According to one example, the platform server (100) may generate (419) an online shop of the seller according to the received request for generating the online shop. For example, the platform server (100) may generate the online shop of each seller in the layer structure. In the online shop, for example, the registered sales products may be uploaded.

According to one example, the supplier terminal (210) or seller terminal (220) may transmit (421) a request for commissioning creation of promotional contents of the sales products to the platform server (100). According to one example, the platform server (100) may transmit (423) the commissioned request for creating contents to the content creator terminal (230). The content creator transmitted with the request for creating may be, for example, one who is suitable for promoting sales products. According to one example, the platform server (100) may determine a content creator suitable to promote the sales products for which the content creation is requested. According to one example, the content creator terminal (230) may transmit (425) the contents for which creation is requested to the platform server (100). According to one example, the platform server (100) may register (427) the received contents. The registered contents may be, for example, uploaded with products in the online shop by the seller. According to another example, the content creator terminal (230) may transmit the contents for which creation is not requested to the platform server (100). The contents for which creation is not requested may be, for example, contents to promote sales products. According to one example, the platform server (100) may register the received contents, and provide them to platform service users through a space where the content creator can be identified. The space where the content creator can be identified may be a space on a SNS service.

According to one example, the platform server (100) may transmit (429) information of the online shop and contents to the purchaser terminal (240) according to the request of the purchaser. For example, the platform server (100) may transmit information about the product sold in the online shop, and contents to promote the product. According to one example, the purchaser terminal (240) may transmit (431) a request for purchasing the corresponding product to the platform server (100) according to the user input. The request for purchasing may include, for example, order and delivery information. According to one example, the platform server (100) may transmit (433) the received order information to the supplier terminal (210). According to one example, the supplier of the supplier terminal (210) may deliver (435) the product to the purchaser according to the received order information.

According to one example, the supplier terminal (210), seller terminal (220), and content creator terminal (230) may transmit (437) a request for settlement of profits of the products sold to the platform server (100). According to one example, the platform server (100) may pay (439) the adjusted amount to the user contributing to the received product sales.

Accordingly, the platform server (100) may allow the content creator to sell products together, and may distribute the profits according to the product sales according to the contribution.

FIG. 5 is a diagram that shows the layer structure of the sellers according to one example.

Referring to FIG. 5, the sellers (510) may be registered in the layer structure consisting of the upper sellers and sub-sellers.

According to one example, the sellers (510) may transmit and receive information for using the platform service by accessing the platform server (e.g.: platform server (100) of FIG. 1) through the seller terminal (e.g.: seller terminal (220) of FIG. 1). The following actions (or, operations) of the sellers (510) may be understood to be made through the seller terminal.

According to one example, the layer structure of the sellers (510) may consist of the upper sellers and the sub-sellers subordinate to the upper sellers. That the sub-sellers are subordinate to the upper sellers may be that the authority of the sub-sellers in the platform service is subordinate to the authority of the upper sellers. In other words, the subordination may mean that the authority of the sub-sellers may be determined in the authority of the upper sellers. The authority may be regarding the range which is registered in the platform service and can be determined when products are sold, such as whether or not to register the sellers, sales products, sales conditions and the like.

According to one example, the layer structure of the sellers (510) may consist of a plurality of layers. Each of the plurality of layers may be, for example, subordinate to the upper layer in order. According to one example, the layer structure of the sellers (510) may consist of a master seller (511), a manager seller (513), and a general seller (515).

According to one example, the master seller (511) may be the top seller of the layer structure. In other words, the master seller (511) may have no subordinate upper seller.

According to one example, registration of the master seller (511) may be determined by the manager of the platform service. According to one example, the master seller (511) may access a registration page of the seller through link information (e.g.: QR code) transmitted by the manager, and transmit application information to the platform server (e.g.: platform server (100) of FIG. 1). According to one example, the manager may determine whether or not to register the master seller (511) according to the objective criteria based on the reliability such as sales volume, capital size and human network size and the like. According to one example, as the master seller (511), one who can sell products stably such as a seller with a volume higher than the designated one, a manager of a community, and the like, may be selected. According to one example, the master seller (511) whose registration is determined by the manager may be registered in the platform service.

According to one example, the master seller (511) may register sales products in the platform service. The sales products may be, for example, at least one of supply products registered in the platform service by the supplier. According to one example, the registration of the sales products may be determined by the manager of the platform service. According to one example, the master seller (511) may transmit application information of the sales products to the platform server. According to one example, the manager may determine whether or not to register the sales products according to the criteria that can determine whether or not to sell products professionally such as the seller's activity area, capital size, conventional sales products, sales volume, and the like. According to one example, the master seller (511) may apply registration of the sales products by category of products. The category of products may include a plurality of products such as fashion, daily necessities, sporting goods, and the like. According to one example, the sales products of which registration is determined by the manager may be registered in the platform service. The registered sales products may be managed in the catalog form. The catalog may be provided to the sub-sellers. According to one example, the sales products of which registration is determined by the manager may be registered in the platform service.

According to one example, the master seller (511) may generate an online shop in which the sales products are registered. The generated online shop may be an online shop directly operated by the master seller (511). The master seller (511) may sell products to the purchasers (520) through the generated online shop.

According to one example, the master seller (511) may manage the subordinate sub-sellers (or, manager seller (513) and general seller (515)). According to one example, the master seller (511) may set the profit rate of the sub-sellers (513, 515). The profit rate may be, for example, a ratio at which the profits of the products sold by the sub-sellers (513, 515) are distributed according to the layer structure. According to one example, the master seller (511) may determine the profit rate when each of the sub-sellers (513, 515) sold products. For example, the master seller (511) may determine the profit rate of the master seller (511) and the manager seller (513) to 40% and 60%, respectively, when the manager seller (513) sells products. In addition, the master seller (511) may determine the profit rate of the master seller (511), the manager seller (513) and general seller (515) to 20%, 20% and 60%, respectively, when the general seller (515) sold products. According to the determined profit rate, profits of each layer for the products sold by the sub-sellers (513, 515). According to one example, the profit rate may be applied to the subordinate upper sellers (511, 513) as a criterion for determining commissions for the upper sellers (511, 513). For example, the general seller (515) may share profits of the products sold to the manager seller (513) to whom he or she is subordinate among the plurality of manager sellers. In addition, also the manager seller (513) may share profits of the products sold to the master seller (511) to whom he or she is subordinate among the plurality of master sellers. Accordingly, the sellers in the layer structure may share the profits of the products sold.

According to one example, the master seller (511) may determine whether or not to register the sub-sellers (513, 515). For example, the master manager (511) may determine whether or not to register not only the manager seller (513), but also the general seller (515) subordinate to the manager seller (513). According to one example, the master seller (511) may check the sales status, delivery status and settlement status of the registered sub-sellers (513, 515).

Accordingly, the master seller (511) is the top seller in the layer structure, and may perform a major role for managing registration of sales products, and directly sell products, and manage the sub-sellers (513, 515).

According to one example, the manager seller (513) may be an intermediate seller. In other words, the manager seller (513) may include an upper seller to whom he or she is subordinate, and a sub-seller to whom he or she is subordinate.

According to one example, registration of the manager seller (513) may be determined by the master seller (511). According to one example, the manager seller (513) may access a registration page of the seller through link information transmitted by the master seller (511), and transmit application information to the platform server. According to one example, it may be determined according to the subjective criteria of the master seller (511). According to one example, the manager seller (513) of which registration is determined by the master seller (511) may be registered in the platform service as the seller subordinate to the master seller (511). According to one example, an additional approval of the manager of the platform service may be needed for registration of the manager seller (513).

According to one example, the manager seller (513) may sell products in the registered sales products of the master seller (511). According to one example, the manager seller (513) may generate an online shop including at least one of the registered products of the master seller (511). The generated online shop may be an online shop directly operated by the manager seller (513). The manager seller (513) may sell products to the purchaser (520) through the generated online shop.

According to one example, the manager seller (513) may manage the subordinate sub-sellers (or, general seller (515)). According to one example, the manager seller (513) may determine whether or not to register the sub-sellers (515) and check the sales status, delivery status and settlement status of the sub-sellers (515). In other words, the manager seller (513) may be granted with the designated authority so as to manage the sub-sellers (515). The designated authority may include at least one of an authority to determine whether or not to register the sub-sellers (515), and an authority to check the sales status, delivery status and settlement status of the general sellers. According to one example, the manager seller (513) may directly sell products through the online shop, but focus on the role of managing the subordinate general sellers (515) more.

Accordingly, the manager seller (513) is an intermediate seller in the layer structure, and may perform a major role (or, intermediate manager role) of managing the general sellers (515), and directly sell products.

According to one example, the general seller (515) may be the lowest seller in the layer structure. In other words, the general seller (515) may not have any subordinate sub-seller.

According to one example, the registration of the general seller (515) may be determined by the upper sellers (or, master seller (515) and manager seller (513)) of the platform service. The registration of the general sellers (515) may be similar to the manager sellers (513). According to one example, the general sellers (515) of which registration is determined by the upper sellers (511, 513) may be registered to the platform service. According to one example, an additional approval of the manager of the platform service may be required for registration of the general sellers (513).

According to one example, the general sellers (515) may sell products among the registered sales products of the master seller (511) as same as the manger sellers (513). According to one example, the general sellers (515) may generate an online shop including at least one of the registered products of the master seller (511). The general sellers (515) may sell products to the purchasers (520) through the generated online shop.

Accordingly, the general seller (515) is the lowest seller in the layer structure, and may perform a major role of selling products.

According to one example, the platform server (or, processor (e.g.: processor (130) of FIG. 2) may register a plurality of manager sellers (513) subordinate to the master seller (511), and register a plurality of general sellers (515) subordinate to each of the plurality of manager sellers (513). According to one example, the platform server may register the manager sellers (513) consisting of a plurality of layers. In other words, the platform server may register the sellers in a layer structure consisting of 3 or more layers.

Accordingly, the platform server may sell products registered more systemically and professionally using the layer structure.

FIG. 6 to FIG. 12 are diagrams that show the GUI (Graphic User Interface) of the master seller according to one example.

The UI of the master seller of FIG. 6 to FIG. 12 may be a GUI displayed through a user interface device (e.g.: display of the user interface device (223) of FIG. 3) of the terminal (e.g.: seller terminal (220) of FIG. 1) of the master seller from the platform server (e.g.: platform server (100) of FIG. 1).

Referring to FIG. 6, the platform server (e.g.: platform server (100) of FIG. 1) may provide the sales status information of own online shop to the master seller through a dashboard GUI (600).

According to one example, the platform server may provide sales information (610) of the online shop of the master seller. For example, the platform server may provide information about the current order amount of this month in real time, and provide information about the last month's order amount and profits. In addition, the platform server may provide annual sales information displayed monthly. Moreover, the platform server may provide information about the percentage of confirming orders, and the percentage of deposit amount compared to the profits.

According to one example, the platform server may provide information (620) about members of the online shop of the master seller. For example, the platform server may provide information about the number of recent member sing-ups, and the percentage of members invited by the master seller among the members.

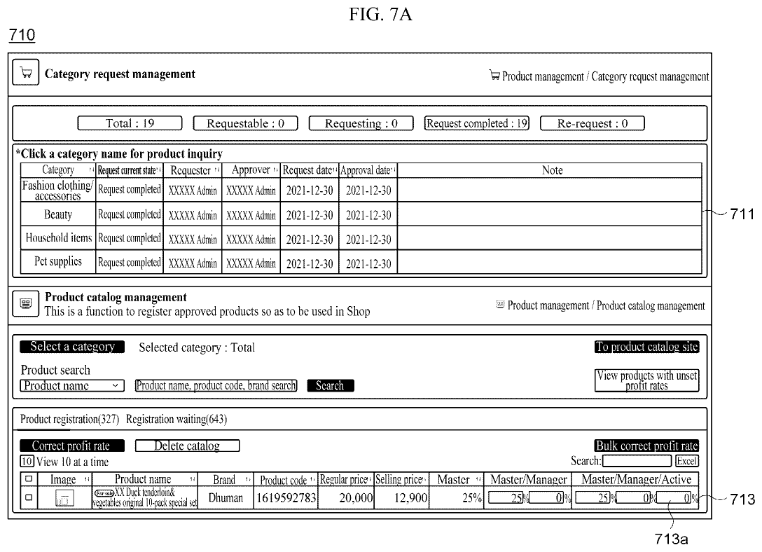

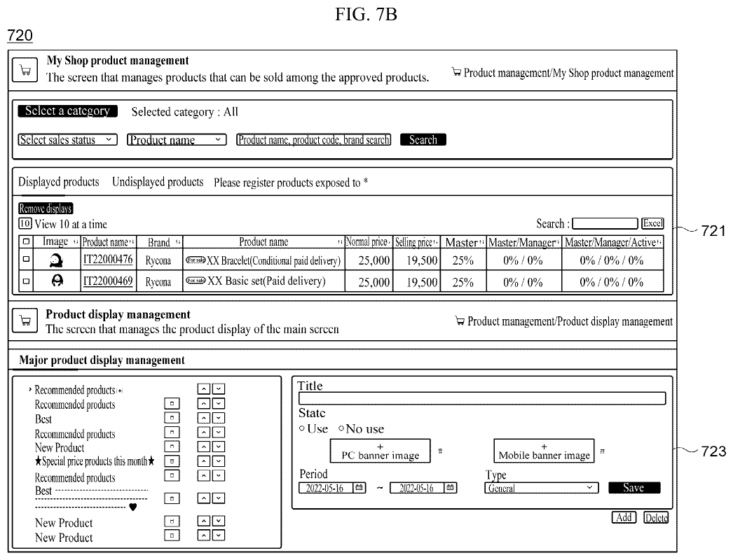

Referring to FIG. 7A, the platform server may provide information related to sales product registration through a registration product management GUI (710).

According to one example, the platform server may provide information (711) of the sales products of which registration is requested. For example, the platform server may provide information about the approval status of the sales products of which registration is applied by category.

According to one example, the platform server may provide information of the registered sales products (or list of the registered sales products) (713). For example, the platform server may provide catalog information of the sales products registered as the request is approved. The catalog information may include, for example, information about the product name, product code, normal price, selling price and the like. According to one example, the platform server may receive information of setting the profit rate of the registered sales products through a user input GUI (713a) for setting the profit rate, included in the information (713) of the sales products. For example, the platform server may receive information of setting the profit rate of the subordinate sub-sellers for distributing sales profits obtained from the sellers. The information of setting may include, for example, information about the profit rate percentage of not only the seller in the intermediately lower layer (e.g.: manger seller (513) of FIG. 5), but also the seller in a further lower layer (e.g.: general seller (515) of FIG. 5). According to one example, the platform server may also receive a request of the seller to delete the sales products registered through the GUI. For example, the platform server may receive a request of the seller to delete the designated registered products in the catalog of the registered sales products.

Accordingly, the master seller may manage registration of the sales products, which is his or her main role, and set the profit rate to distribute the profits of the products sold according to the layer structure.

Referring to FIG. 7B, the platform server may provide information about the products of the online shop to the master seller through a shop product management GUI (720).

According to one example, the platform server may provide information of the sales products registered in the online shop of the master seller. For example, the platform server may provide not only information of the product name and the like, but also information about the set profit rate of each seller through the product management GUI (710).

According to one example, the platform server may provide display information (723) of the online shop of the master seller. For example, the platform server may provide menu information that sales products of the online shop are positioned and the like.

According to one example, the platform server may receive information required for displaying products through a user input GUI (723a) for display of the sales products, included in the display information (723) of the online shop. For example, the platform server may be a menu that sales products are positioned, a title of a sales page, a content for describing products, a sales period, a sales type, and the like. The content may be provided, for example, by the content creator registered in the platform service.

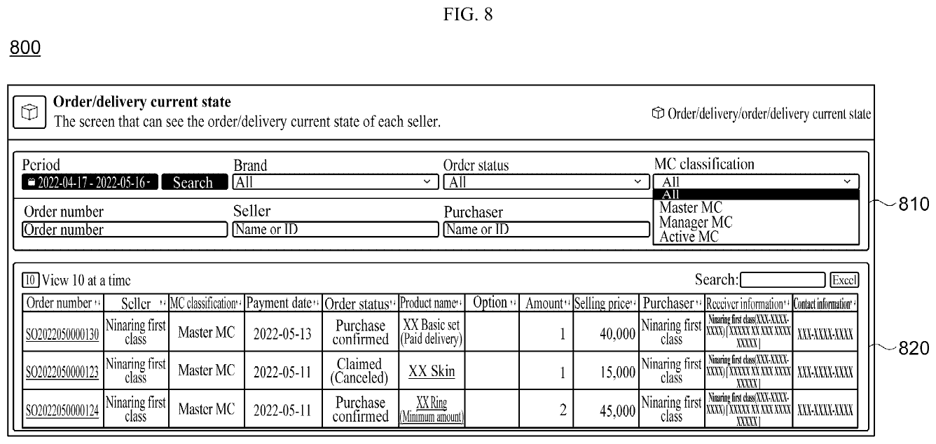

Referring to FIG. 8, the platform server may provide information about products sold in the online shop to the master seller through the management GUI (800) of the products sold.

According to one example, the platform server may provide order and delivery information (810) of the products sold. For example, the platform server may provide the order number, order status, purchaser information, delivery current state, and the like.

According to one example, the platform server may provide order and delivery information (810) of not only his or her own, but also the subordinate sub-sellers to the master seller. For example, the platform server may provide the order and delivery information of the selected sub-seller, when a request of the master seller is received through a user input GUI (820) to search order and delivery information.

Accordingly, the master seller may manage order the delivery of the subordinate sub-seller, together with the major role of product registration and the like.

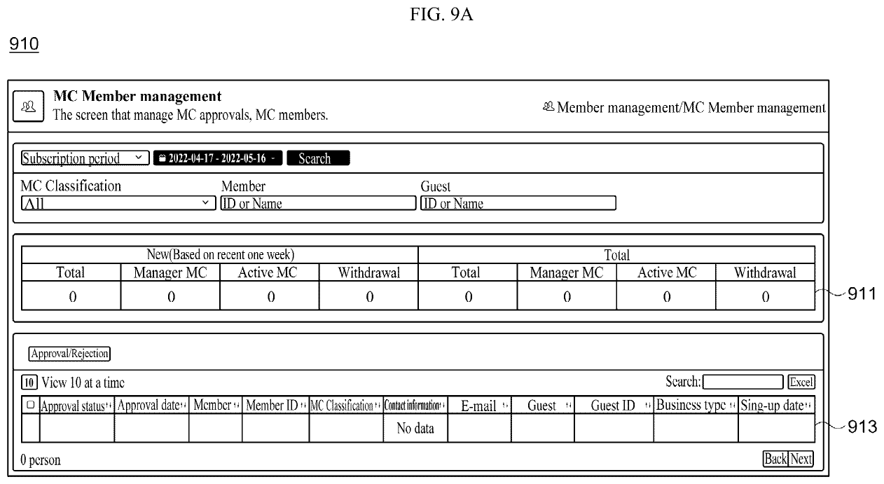

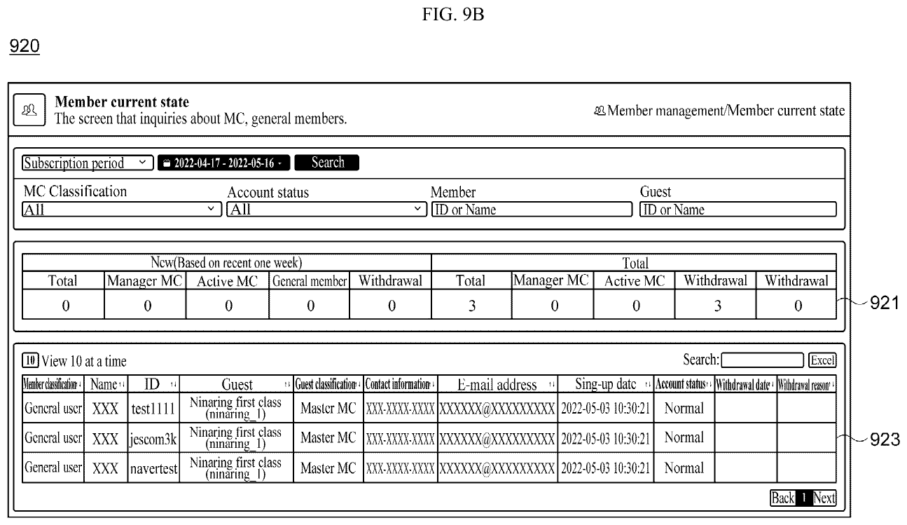

Referring to FIG. 9A, the platform server may provide information about the sub-sellers subordinate to the master seller through a seller management GUI (910).

According to one example, the platform server may provide current state information (911) of the sub-sellers. For example, the platform server may provide information about the number of people of the sub-sellers by layer. In addition, the platform server may provide information about a new sub-seller separately, when the headcount of the sub-sellers is provided.

According to one example, the platform server may provide information (913) of the sub-sellers of which registration is requested. For example, the platform server may provide information of the manager sellers and general sellers requiring approval of the master seller. According to one example, the platform server may register the sub-sellers in the platform service, when the approval of registration of the sub-sellers is received from the master seller.

Accordingly, the master seller may check the status of the sub-sellers and manage registration.

Referring to FIG. 9B, the platform server may provide information about purchasers registered as a member in the online shop to the master seller through a member management GUI (920).

According to one example, the platform server may provide the member current information (921). For example, the platform server may provide information about the headcount of not only the members of the master seller, but also the members of the subordinate sub-sellers. In addition, the platform server may provide information about a new sub-seller separately, when the headcount of the members is provided.

According to one example, the platform server may provide information (923) about the configuration ratio of the purchasers of the online shop of the sellers. For example, the platform server may provide information about the percentage of non-members among the purchasers.

According to one example, the platform server may provide information (923) about the configuration ratio of the purchasers of the online shop of not only the master seller but also the subordinate sub-sellers. For example, the platform server may provide information about the percentage of the non-members of the purchasers of the online shop of the selected manager seller and general seller, when a request of the master seller is received through a user input GUI (925) to search member information.

Accordingly, the master seller may manage the members of the subordinate sub-sellers as well as his or her own members.

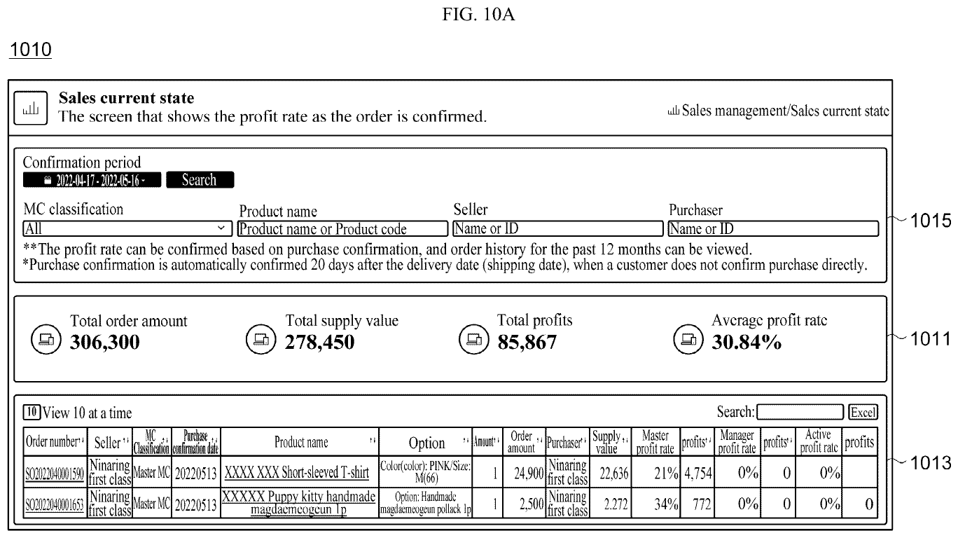

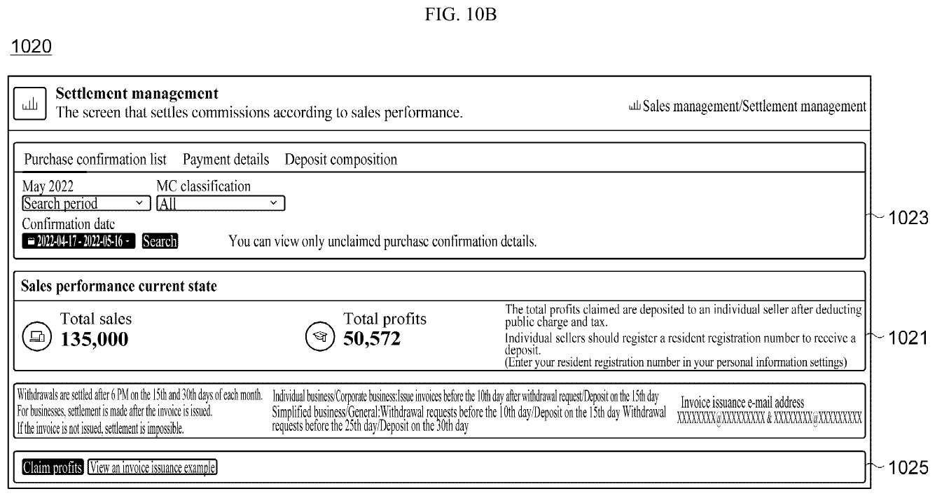

Referring to FIG. 10A, the platform server may provide information about the sales status of the online shop to the master seller through a sales current state management GUI (1010).

According to one example, the platform server may provide sales information (1011) of the online shop. For example, the platform server may provide sales current state information about the current order amount, supply value, profits, profit rate, and the like. The sales current state information may be information more focused on the current sales status compared to the sales information (610) provided through the dashboard GUI (600) of FIG. 6.

According to one example, the platform server may provide order and delivery information (1013). For example, the platform server may be similar to order and delivery information (810) provided through the management GUI (800) of the products sold of FIG. 8.

According to one example, the platform server may provide sales information (1011) of the online shop, and order and delivery information (1013) of not only the master seller, but also the subordinate sub-sellers. For example, the platform server may provide sales information of the online shop, and order and delivery information of the selected sub-seller, when a request of the master seller is received through a user input GUI (1015) to search sales information and the like.

Accordingly, the master seller may manage the sales information of the online shop, and order and delivery information of the sub-seller, together with the major role of product registration and the like.

Referring to FIG. 10B, the platform server may provide settlement information of the profits to the master seller through a settlement management GUI (1020).

According to one example, the platform server may provide settlement information (1021). For example, the platform server may provide profits information about the sales and profits and the like. The profit information may be, for example, information more focused on the adjusted amount compared to the sales information (1011) provided through a sales current state management GUI (1010).

According to one example, the platform server may provide settlement information (1021) of not only the master seller, but also the subordinate sub-sellers to the master seller. For example, the platform server may provide settlement information of the selected sub-seller, when a request of the master seller is received through a user input GUI (1023) to search settlement information.

According to one example, the platform server may receive a request for settling profits through a user input GUI (1025) for settlement. According to one example, the platform server may handle a process of settling profits, when a request of the master seller is received.

Accordingly, the master seller may manage profit information of the sub-sellers, together with a major role of product registration and the like.

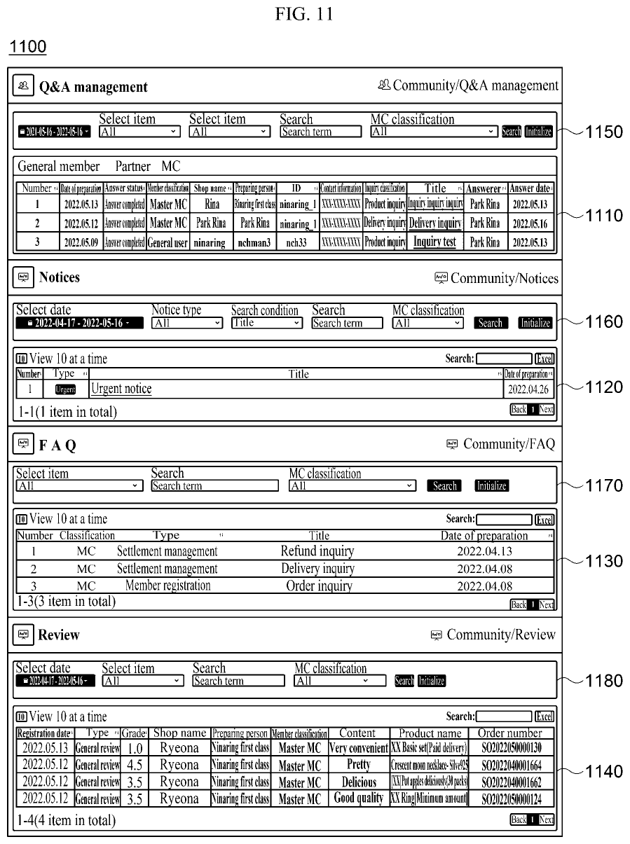

Referring to FIG. 11, the platform server may provide community information required for selling products to the master seller through a community management GUI (1100).

According to one example, the platform server may provide Q&A information (1110), notice information (1120), FAQ information (1130) and review information (1140) related to product sales. For example, the platform server may provide Q&A information, notice information, FAQ information and review information about sales products, order, delivery, and the like.

According to one example, the platform server may check Q&A information, notice information, FAQ information and review information of the subordinate sub-sellers, when a request of the master seller is received through a user input GUI (1150, 1160, 1170, 1180) to search community information.

Accordingly, the master seller may manage community information of not only his or her own but also the sub-sellers.

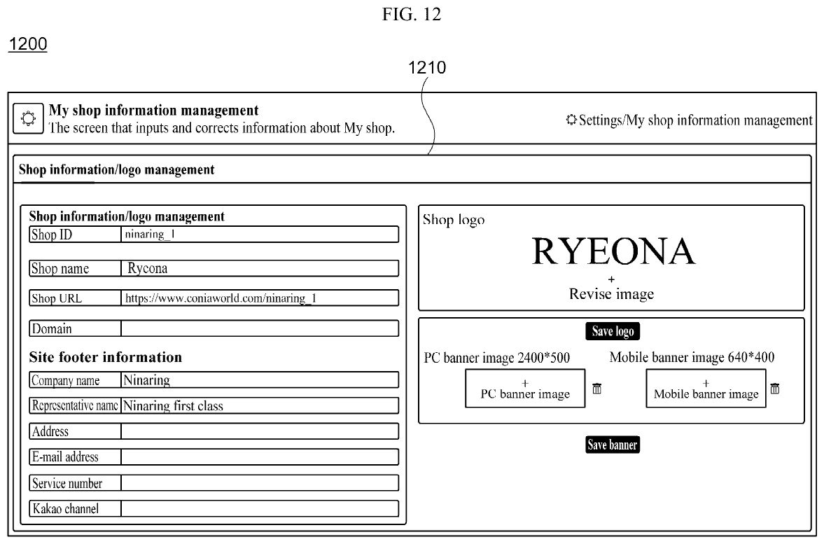

Referring to FIG. 12, the platform server may manage his or her online shop to the master seller through an online shop management GUI (1200).

According to one example, the platform server may provide information (1210) of the online shop of the master seller. For example, the platform server may provide information that can identify the online shop such as a shop ID, a shop name, a URL, a domain, a shop logo and the like, and information about the entity operating the online shop such as a company name, a representative name, an address and the like. According to one example, the platform server may store (or, correct) information (1210) of the online shop based on the request inputted through a GUI including the information (1210) of the online shop.

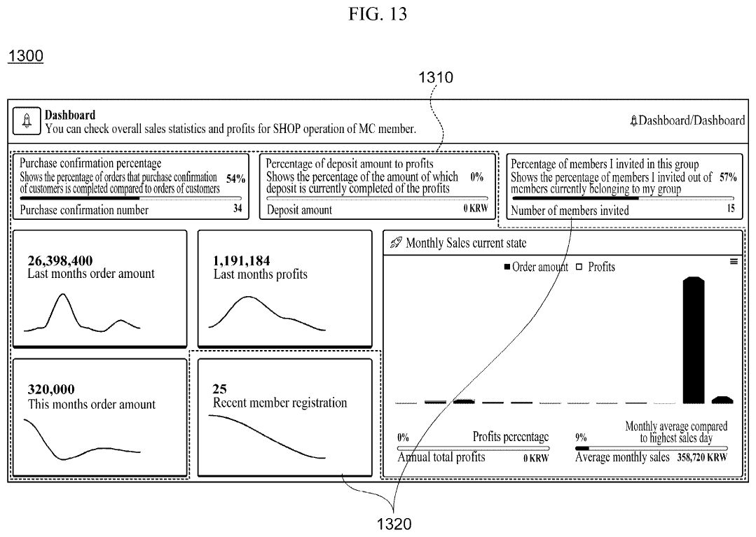

FIGS. 13 to 19B are diagrams that show the GUI of the manager seller and general seller according to one example.

The UI of the general seller of FIG. 13 to FIG. 19B may be a GUI displayed through a user interface device (e.g.: display of the user interface device (223) of FIG. 3) of the terminal of the general seller (e.g.: seller terminal (220) of FIG. 1) from the platform server (e.g.: platform server (100) of FIG. 1).

Referring to FIG. 13, the platform server (e.g.: platform server (100) of FIG. 1) may provide sales status information of his or her own online shop to the manager seller and general seller through a dashboard GUI (1300).

According to one example, the platform server may provide sales information of the online shop (1310) and information about members of the online shop (1320) of the manager seller and general seller similarly to FIG. 6.

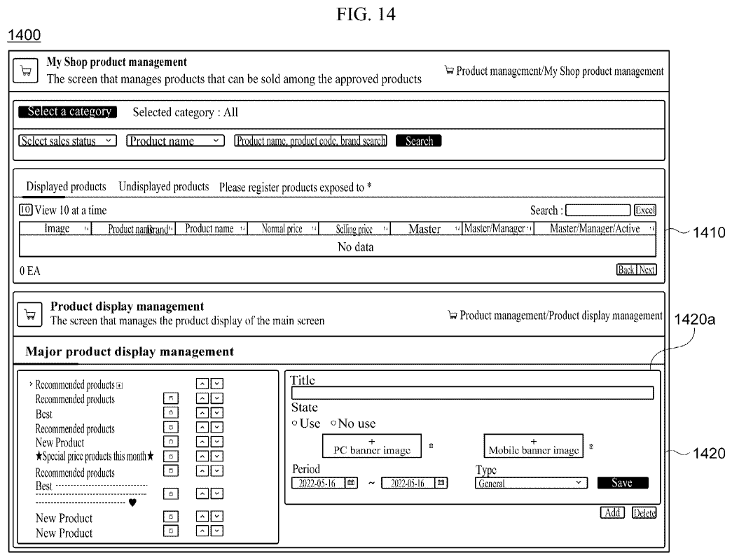

Referring to FIG. 14, the platform server may provide information about products of the online shop to the manager seller and general seller through a shop product management GUI (1400).

According to one example, the platform server may not provide a service like the GUI (710) for managing registration of the sales products of FIG. 7A to the manager seller and general seller.

According to one example, the platform server may provide information (1410) of sales products registered in the online shop of the manager seller and general seller. For example, the platform server may provide only the information such as a product name and the like. According to one example, the platform server may provide information such as a product name, a product code, a normal price, a selling price and the like, but may not provide the profit rate input by the master seller through the GUI (713a) for setting the profit rate in FIG. 7A.

According to one example, the platform server may provide display information (1420) of the online shop, and receive information required for displaying products through a user input GUI (1420a) for product display similarly to FIG. 7B.

Accordingly, the manager seller and general seller may register the sales products of which profit rate is set by the master seller in each online shop.

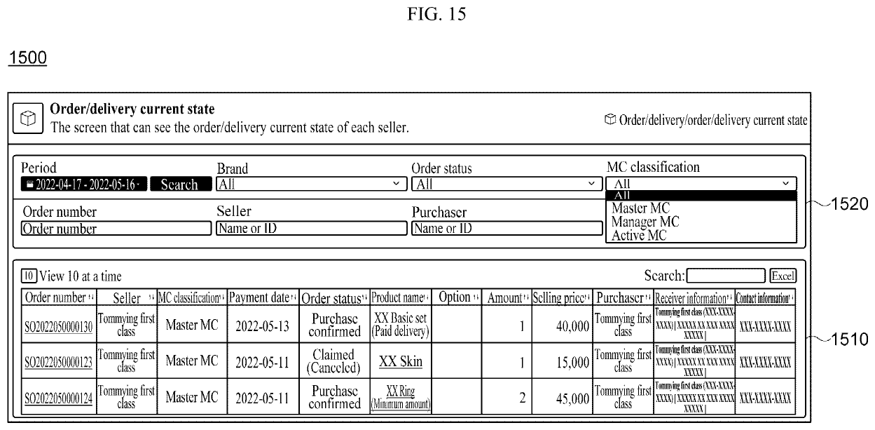

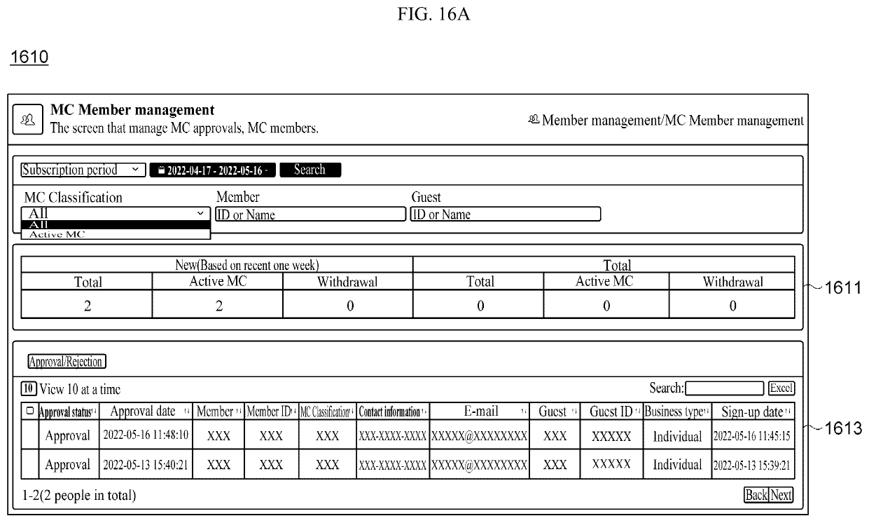

Referring to FIG. 15, the platform server may provide information about products sold in the online shop to the manager seller and general seller through a management GUI (1500) of the products sold.

According to one example, the platform server may provide order and delivery information (1510) of the products sold similarly to FIG. 8.

According to one example, the platform server may provide order and delivery information (1510) of not only his or her own, but also the general seller to the manager.

For example, the platform server may provide order and delivery information of the selected general seller, when a request of the manager seller is received through a user input GUI (1520) to search order and delivery information similarly to the master seller of FIG. 8. On the other hand, the platform server may provide only his or her own order and delivery information (1510) to the general seller. ‘MC classification” for selecting the type of the sellers in the user input GUI (1520) to search the order and delivery information may be not provided in the GUI of the general sellers.

Accordingly, the manager seller may manage order and delivery of the sub-sellers, as his or her major role of managing the general sellers.

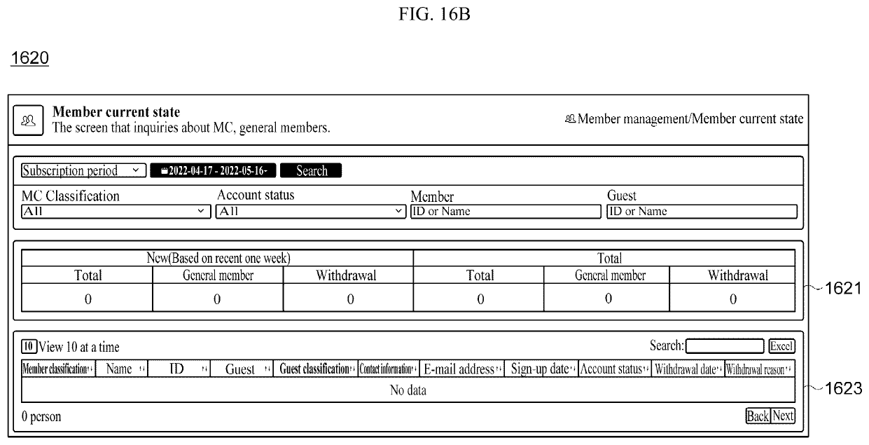

Referring to FIG. 16A, the platform server may provide information about the general sellers subordinate to the manager seller through a seller management GUI (1610).

According to one example, the platform server may provide current state information of (1611) of the general seller, and information (1613) of the general seller of which registration is requested, to the manager seller similarly to FIG. 9A. According to one example, the platform server may not provide a seller management GUI (1610) to the general sellers.

Accordingly, the manager seller may manage the status and registration of the sub-sellers, as his or her major role of managing the general sellers.

Referring to FIG. 16B, the platform server may provide information about purchasers registered as a member in the online shop to the manager seller and general seller through a member management GUI (1620).

According to one example, the platform server may provide the current state information (1621) of the members. For example, the platform server may provide information about the headcount of his or her members, but also the members of the general seller, similarly to FIG. 9B. On the other hand, the platform server may provide only the information about the headcount of his or her members to the general seller.

According to one example, the platform server may provide information (1623) about the composition ratio of the purchasers of the online shop of the seller similarly to FIG. 9B.

Accordingly, the manager seller may check the members of the sub-sellers, as his or her major role of managing the general sellers.

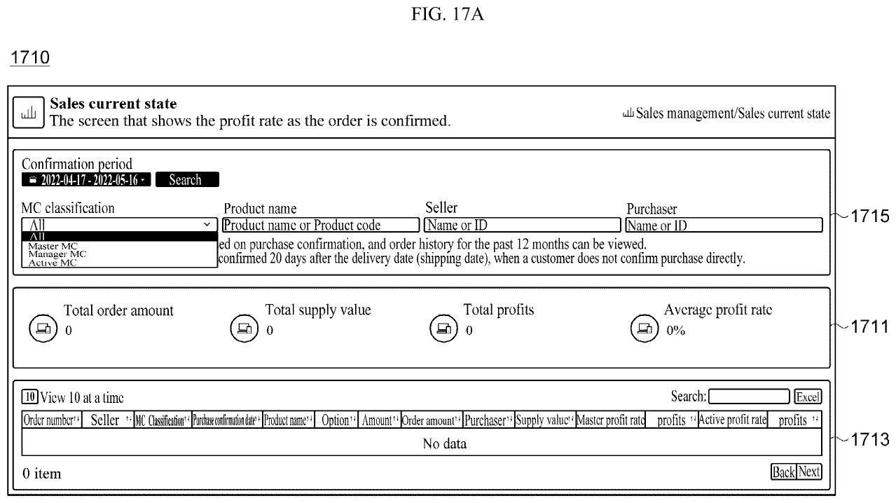

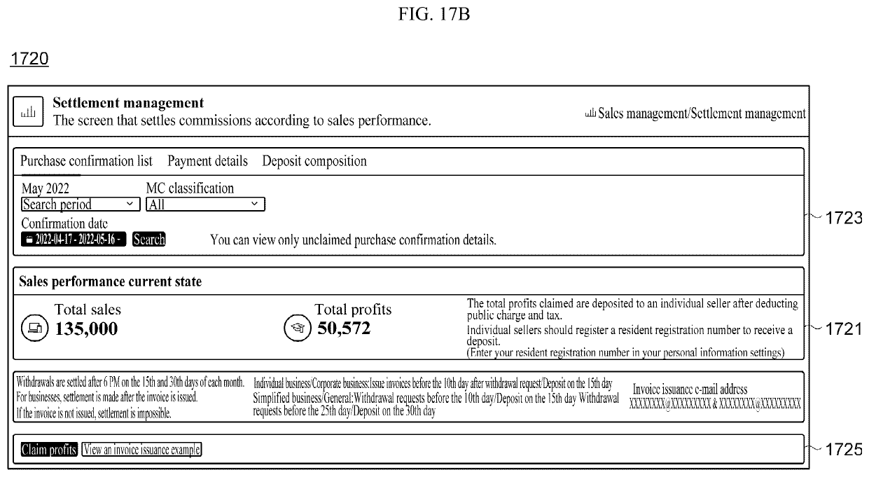

Referring to FIG. 17A, the platform server may provide information about the sales status of the online shop to the manager seller and general seller through a sales current state GUI (1710).

According to one example, the platform server may provide sales information (1711) of the online shop, and order and delivery information (1713) similarly to FIG. 10A.

According to one example, the platform server may provide sales information (1711) of the online shop, and order and delivery information (1713) of not only his or her own, but also the general seller to the manager seller. For example, the platform server may provide sales information of the online shop, and order and delivery information of the selected general seller, when a request of the manager seller is received through a user input GUI (1715) to search sales information and the like similarly to the master seller of FIG. 10A. ‘MC classification” for selecting the type of the sellers in the user input GUI (1730) to search the sales information and the like may be not provided in the GUI of the general sellers.

Accordingly, the manager seller may manage sales information of the online shop, and order and delivery information of the general sellers, as his or her major role of managing the general sellers.

Referring to FIG. 17B, the platform server may provide settlement information of profits to the manager seller and general seller through a settlement management GUI (1720).

According to one example, the platform server may provide settlement information (1721) similarly to FIG. 10B.

According to one example, the platform server may provide settlement information (1721) of not only his or her own, but also the general sellers to the manager seller. For example, the platform server may provide settlement information of the selected general seller, when a request of the manager seller is received through a user input GUI (1725) to search settlement information similarly to the master manager of FIG. 10B. On the other hand, the platform server may provide only his or her own settlement information (1721) to the general sellers. On the other hand, ‘MC classification” for selecting the type of the sellers in the user input GUI (1725) to search the settlement information may be not provided in the GUI of the general sellers.

According to one example, the platform server may receive a request for settling profits through a user input GUI (1725) for settlement similarly to FIG. 10B. According to one example, the platform server may handle a process of settling profits, when a request of the manager seller and general seller is received.

Accordingly, the manager seller may manage settlement information of the general sellers, as his or her major role of managing the general sellers.

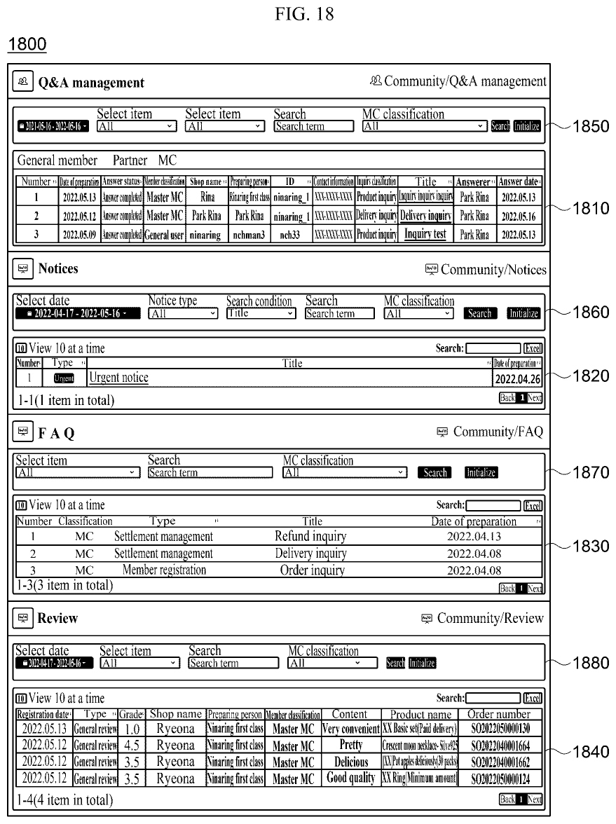

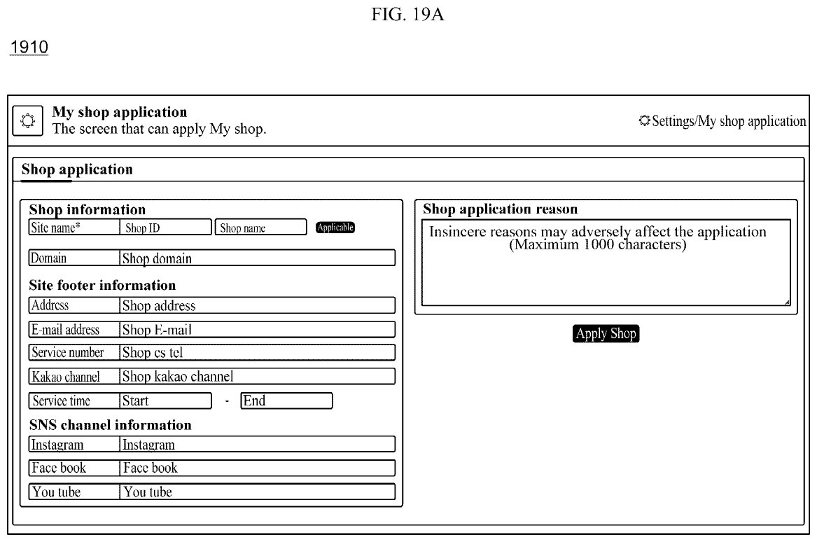

Referring to FIG. 18, the platform server may provide community information required for selling products to the manager seller and general seller through a community management GUI (1800).

Referring to FIG. 18, the platform server may provide community information required for selling products to the manager seller and general seller through a community management GUI (1800).

According to one example, the platform server may provide Q&A information (1810), notice information (1820), FAQ information (1830) and review information (1740) related to product sales similarly to FIG. 11.

According to one example, the platform may check Q&A information, notice information, FAQ information and review information of the subordinate general sellers, when a request of the manager seller is received through a user input GUI (1850, 1860, 1870, 1880) to search community information similarly to FIG. 11. On the other hand, ‘MC classification” for selecting the type of the sellers in the user input GUI (1850, 1860, 1870, 1880) to search the community information may be not provided in the GUI of the general sellers.

Accordingly, the manager seller may manage community information of the general sellers, as his or her major role of managing the general sellers.

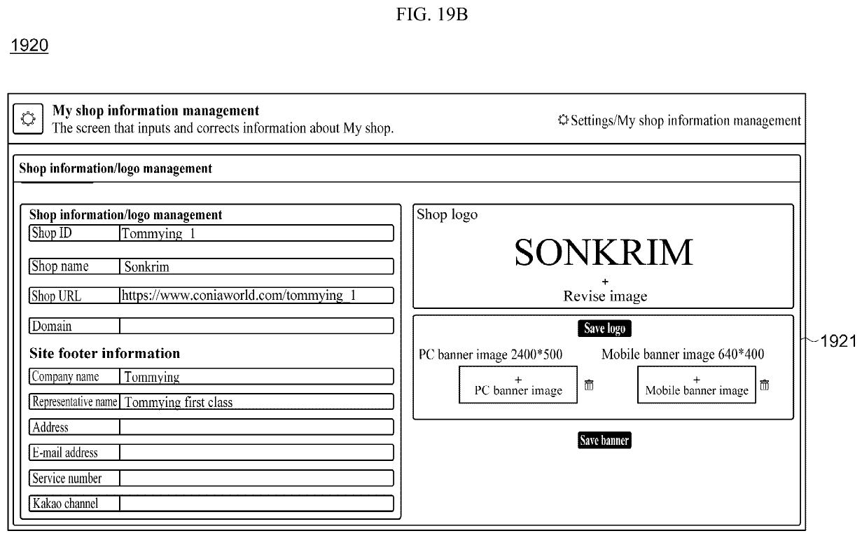

Referring to FIG. 19A, the platform server may make the manager seller and general seller to apply an online shop through an online shop application GUI (1910).

According to one example, the platform server may provide information required for applying an online shop to the manager seller and general seller through an online shop application GUI (1910). For example, the platform server may provide information that can identify the online shop such as a shop ID, a shop name, a URL, a domain, a shop logo and the like, and information about the entity operating the online shop such as a company name, a representative name, an address and the like. According to one example, the platform server may transmit information required for generating an online shop to the master seller. According to one example, the platform server may generate an online shop of the manager seller and general seller, when a response of approving the online shop is received.

Referring to FIG. 19B, the platform server may make the manager seller and general seller to manage his or her online shop through an online shop management GUI (1920).

According to one example, the platform server may provide information (1921) of the online shop of the manager seller and general seller similarly to FIG. 12. According to one example, the platform server may store (or, correct) information of the online shop based on the user input inputted through a GUI including information (1921) of the online shop.

According to one example, the platform server may provide information (1921) of the online shop of the manager seller and general seller similarly to FIG. 12. According to one example, the platform server may store (or, correct) information (1921) of the online shop based on a request inputted through a GUI including information (1921) of the online shop.

FIG. 13 to 19B are diagrams that show the GUI of the manager seller and general seller according to one example.

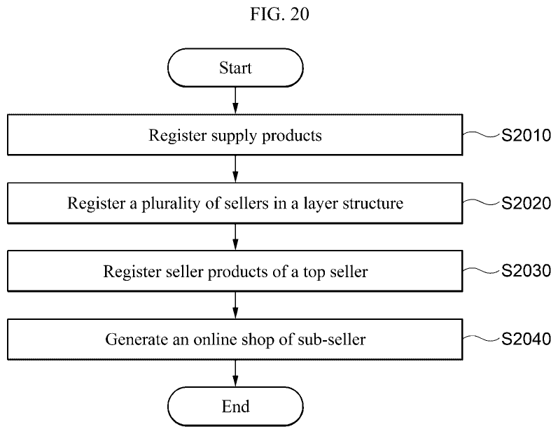

Referring to FIG. 20, the platform server (e.g.: platform server (100) of FIG. 1) may provide an e-commerce platform service in which the supplier, seller and content supplier of a product participate together to sell the product to the purchaser.

According to one example, in the S2010 operation, the platform server may register supply products to be sold in the platform service. For example, the platform server may register supply products based on a response of the platform manager (hereinafter, manager). The manager may approve registration of the supply products according to the stringent criteria in consideration of for example, product quality, market share, and the like. According to one example, the platform server may register the product suppliers of the registered products in the platform service. Whether or not to register the suppliers may be determined according to the stringent criteria in consideration of the business period, sales volume and the like similarly to the determination of whether or not to register products.

According to one example, in the S2020 operation, the platform server may register a plurality of sellers in a layer structure consisting of upper sellers and at least one sub-sellers subordinate to the upper sellers. For example, the platform server may register the top seller as the master seller, and register subordinate sub-seller as the manager seller, and general manager subordinate to the manger seller, in the platform service.

According to one example, in the S2030 operation, the platform server may register the sales products of the top seller in the platform service. For example, the platform server may register the sales products selected among the supply products based on the response of the manager. The manager may approve registration in consideration of for example, area of activity, sales volume and the like. According to one example, the platform server may grant an authority to manage the sales status, delivery status and settlement status of the general sellers to the manager seller. According to one example, the platform server may register a content creator who promotes the registered sales products in the platform service. According to one example, the platform server may register the contents created by the content creator in the platform service. The registered contents may be shared with content users, for example, through a space that can identify the content creator.

According to one example, in the S2040 operation, the platform server may generate an online shop of the sub-seller subordinate to the top seller. For example, the platform server may generate an online shop of the general seller in which the sales products of the master seller are registered. The online shop may be generated, for example, based on the input of the general seller. According to one example, the platform server may generate order information of purchasers sold through the online shop. The sold products may be, for example, products sold through the contents registered in the platform service. According to one example, the platform server may transmit the purchase information to the suppliers and make them deliver them to the purchasers.

According to one example, the S2010 to S2040 operations may be implemented by a computer program which is stored in a computer readable storage medium and is configured to be executed by at least one processor. The computer program may include an instruction set in which the S2010 to S2040 operations are implemented by a programming language.

The e-commerce platform service provided through the platform server (100) according to various examples described in FIG. 1 to FIG. 20 gathers suppliers, sellers and content creators for distributing and selling products in one platform service, thereby easily finding a professional outside his own field and cooperating with each other to sell products. In addition, the e-commerce platform service can reduce risks that users who cooperate in selling products should bear when they sell products on their own, and enable them to focus on their respective professional field and do their best, and further promote product sale by distributing sales profits depending on the ratio of contributing to product sale, thereby making a virtuous cycle structure that increasing each one's profit and develops in each ones' field. Furthermore, this virtuous cycle of the e-commerce platform service can prevent damage to suppliers and sellers due to competition for the lowest price in the conventional open market, and form a sound market that provides high-quality products to purchasers at reasonable prices.

Furthermore, the e-commerce platform service of the platform server (100) can provide various online shops according to the tastes of the plurality of sellers to purchasers and also systemically divide roles to sell products, by registering a plurality of sellers in a layer structure of higher layers and lower layers in the platform service, and at the same time, can bring greater profits to the e-commerce platform users as a greater market is formed, since content creators or purchasers who are participants of the e-commerce platform service, are registered as participants again.

1. An e-commerce platform server comprising;
a communication device;
a memory storing one or more instructions; and
a processor executing the one or more instructions stored in the memory,
wherein the processor, by executing the one or more instructions, is configured to:
register supply products of a supplier to be sold in a platform service in a supply product DB, database (DB);
register a plurality of sellers in a seller DB in a layer structure consisting of an upper seller and at least one sub-seller subordinate to the upper seller;
register sale products of a top seller of the layer structure in a sales product DB, wherein the sale products are at least one of the supply products registered in the supply product DB; and
generate an online shop of a sub-seller comprising at least one of the registered sale products of the top seller, wherein the sub-seller is subordinate to the top seller.

2. The e-commerce platform server according to claim 1, wherein the processor, by executing the one or more instructions, is configured to determine whether or not to register the top seller based on a response of a manager of the platform service, when the top seller is registered in the seller DB.

3. The e-commerce platform server according to claim 2, wherein the processor, by executing the one or more instructions, when the sub-seller is registered in the seller DB, is configured to:
transmit information of the sub-seller to a terminal of the upper seller subordinated by the sub-seller;
receive a response that determines whether or not to register from the terminal of the upper seller; and
determine whether or not to register from the terminal of the upper seller according to the received response.

4. The e-commerce platform server according to claim 1, wherein the processor, by executing the one or more instructions, when the plurality of sellers are registered in the layer structure, is configured to:
register the top seller in the seller DB as a master seller,
register the sub-seller subordinate to the top seller as a manager seller, and a general seller subordinate to the manager seller in the seller DB, and
grant a designated authority to manage the general seller to the manager seller.

5. The e-commerce platform server according to claim 4, wherein the designated authority comprises at least one of an authority to determine whether or not to register the general seller, and an authority to check the sales status, delivery status and settlement status of the general seller.

6. The e-commerce platform server according to claim 4, wherein the processor, by executing the one or more instructions, is configured to:
register a plurality of manager sellers subordinate to the master seller,; and
register a plurality of general sellers subordinate to each of the plurality of manager sellers.

7. The e-commerce platform server according to claim 1, wherein the processor, by executing the one or more instructions, is configured to:
receive information for setting the profit rate according to the layer structure from the terminal of the top seller; and
set the profit rates of the sellers of the layer structure according to the information for setting the received profit rate.

8. The e-commerce platform server according to claim 7, wherein the processor, by executing the one or more instructions, in case of receiving the information for setting the profit rate, is configured to:
recommend the profit rate of the subordinate sub-seller, when information for setting the profit rate of the top seller is received,; and
set profits of the sellers of the layer structure according to the recommended profit rate, when an input of the top seller who agrees the recommended profit rate is received.

9. The e-commerce platform server according to claim 1, wherein the processor, by executing the one or more instructions, is configured to provide a UI (User Interface) corresponding to authority information set for the seller, for each terminal of the plurality of sellers, based on the layer structure.

10. The e-commerce platform server according to claim 9, wherein the processor, by executing the one or more instructions, is configured to provide an UI for managing the status of the sub-seller subordinate to the upper seller through the terminal of the upper seller.

11. The e-commerce platform server according to claim 10, wherein the processor, by executing the one or more instructions, is configured to provide an UI for managing registration of the subordinate sub-seller and check status information through the terminal of the upper seller.

12. The e-commerce platform server according to claim 9, wherein the processor, by executing the one or more instructions, is configured to provide an UI for registering sale products through the terminal of the top seller.

13. An electronic device comprising;
a communication device;
a user interface device;
a memory storing one or more instructions; and
a processor executing the one or more instructions stored in the memory,
wherein the processor, by executing the instructions, is configured to:
transmit application information for being registered as an upper seller of a layer structure, to which a sub-seller is subordinate, to an e-commerce platform server, thereby registering as an upper seller;
register sale products in a sales product database (DB), through the e-commerce platform server, when registered as a top seller of the layer structure, wherein the sale products are at least one of supply products registered in a supply product DB by a supplier; and
manage the subordinate sub-seller, through the e-commerce platform server.

14. The electronic device according to claim 13, wherein the processor, by executing the one or more instructions, is configured to:
receive a request for registering the subordinate sub-seller in a seller DB from the e-commerce platform server; and
transmit a response that determines whether or not to register the sub-seller based on a user input to the e-commerce platform server.

15. The electronic device according to claim 13, wherein the processor, by executing the one or more instructions, is configured to:
receive a request for determining whether or not to generate an online shop of the sub-seller from the e-commerce platform server; and
transmit a response that determines whether or not to generate the online shop of the sub-seller based on a user input to the e-commerce platform server.

16. The electronic device according to claim 13, wherein the processor, by executing the one or more instructions, is configured to:
transmit a request for checking at least one of the sales status, delivery status, and settlement state of the subordinate sub-seller based on a user input; and
provide the received information to the user, when information corresponding to the request for checking is received from the e-commerce platform server.

17. An electronic device comprising;
a communication device;
a user interface device;
a memory storing one or more instructions; and
a processor executing the one or more instructions stored in the memory,
wherein the processor, by executing the instructions, is configured to:
transmit application information for being registered as an sub-seller of a layer structure, to which a sub-seller is subordinated to an upper seller, to an e-commerce platform server, thereby registering as an sub-seller; and
generate an online shop comprising at least one of sale products of a top seller of the layer structure, through the e-commerce platform server.

18. The electronic device according to claim 17, wherein the processor, by executing the instructions, when the online shop is generated, is configured to:
receive a tool for generating the online shop from the e-commerce platform server;
receive a user input for setting the online shop through the received tool; and
transmit the received user input to the e-commerce platform server.

19. A method for providing an e-commerce platform service, the method comprising;
registering supply products of a supplier to be sold in a platform service in a supply product database (DB);
registering a plurality of sellers in a seller DB in a layer structure consisting of an upper seller and at least one sub-seller subordinate to the upper seller;
registering sale products of a top seller of the layer structure in a sales product DB, wherein the sale products are at least one of the supply products registered in the supply product DB; and
generating an online shop of a sub-seller comprising at least one of the registered sale products of the top seller, wherein the sub-seller is subordinate to the top seller.

20. A computer program stored in a computer readable storage medium, and configured to be executed by one or more processors,
wherein the computer program comprises;
an instruction to register supply products of a supplier to be sold in a platform service in a supply product database (DB);
an instruction to register a plurality of sellers in a seller DB in a layer structure consisting of an upper seller and at least one sub-seller subordinate to the upper seller;
an instruction to register sales product of a top seller in the layer structure in a sales product DB, wherein the sale products are at least one of the supply products registered in the supply product DB; and
an instruction to generate an online shop of a sub-seller comprising at least one of the registered sale products of the top seller, wherein the sub-seller is subordinate to the top seller.
